(19) United States
(12) Patent Application Publication
(10) Pub. No.: US 2024/0422833 A1
(43) Pub. Date: Dec. 19, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/820,221

(22) Filed: Aug. 29, 2024

Related U.S. Application Data
(63) Continuation of application No. PCT/CN2023/079530, filed on Mar. 3, 2023.

(30) Foreign Application Priority Data
Mar. 5, 2022 (CN) 202210211293.2

(51) Int. Cl. H04W 74/0838; H04W 56/00

(52) U.S. Cl. CPC H04W 74/0838; H04W 56/0045

(57) ABSTRACT

The present application discloses a method and a device in a communication node for wireless communications. The communication node transmits a first signal, the first signal including at least a random access preamble; and monitors a first signaling in a first time window, the first signaling being used to schedule a random access response for the first signal, an end time in time domain of the first signal being used to determine a start of the first time window; the first signal is associated with a first resource set, the first resource set belonging to a first resource pool, the first resource pool including multiple resource sets; at least one spatial parameter of the first signaling is related to at least one of an index of the first resource set in the first resource pool or an index of the first resource pool.

### CROSS REFERENCE TO RELATED APPLICATIONS

This application is the continuation of the International Patent application No. PCT/CN2023/079530, filed on Mar. 3,2023, and claims the priority benefit of Chinese Patent Application No.202210211293.2, filed on Mar. 5,2022, the full disclosure of which is incorporated herein by reference.

### BACKGROUND

### TECHNICAL FIELD

The present application relates to transmission methods and devices in wireless communication systems, and in particular to a method and device for Multiple Input Multiple Output (MIMO) transmission in a wireless communication system.

### RELATED ART

MIMO is a key technique of the New Radio (NR) system, which has been successfully commercialized. In Release (Rel)-15/16/17, the 3rd GenerationPartner Project (3GPP) has worked on the standardization of Frequency Division Duplex (FDD) and Time Division Duplex (TDD) systems after studying the properties of MIMO, where the focus of studies is for Downlink (DL) MIMO operations. Targeting the Uplink (UL) MIMO, which is considered as a key direction of studies of 3GPP in Rel-18, the 3GPP RAN94e conference has decided on the conduction of the study item of “MIMO Evolution for Downlink and Uplink”, where a further study is required for the provision of additional uplink multiple Transmit/Receive Point (multi-TRP) deployment with enhanced uplink performance by providing two Timing Advances (TAs) and enhanced uplink power control.

### SUMMARY

If a UE (i.e., User Equipment) performs uplink transmission through two TRPs with different timing advances, how to determine the spatial parameters used for monitoring responses to a PRACH (i.e., Physical Random Access Channel) when the UE performs a Random Access (RA) procedure needs to be enhanced; and furthermore, when a Random Access procedure is triggered by a PDCCH (i.e., Physical Downlink Control Channel) order, how to determine the parameters of the PRACH needs to be enhanced.

To address the above problem, the present application provides a solution. In the description of the above problem, New Radio (NR) scenario is used as an example; the present application is equally applicable to scenarios such as Long Term Evolution (LTE) where similar technical effect can be achieved. Additionally, the adoption of a unified solution for various scenarios contributes to the reduction of hardcore complexity and costs.

To address the above problem, the present application provides a solution. In the description of the above problem, the TN (i.e., Terrestrial Network) scenario is used as an example; the present application is equally applicable to, for example, NTN (i.e., Non-Terrestrial Network) scenarios, to achieve technical effects similar to those in the TN scenario. Additionally, the adoption of a unified solution for various scenarios contributes to the reduction of hardcore complexity and costs.

To address the above problem, the present application provides a solution. In the description of the above problem, the uu-interface scenario is used as an example; the present application is equally applicable to, for example, the sidelink scenario, to achieve similar technical effects as in the uu-interface scenario. Additionally, the adoption of a unified solution for various scenarios contributes to the reduction of hardcore complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:

transmitting a first signal, the first signal including at least a random access preamble; and

monitoring a first signaling in a first time window, the first signaling being used to schedule a random access response for the first signal, an end time in time domain of the first signal being used to determine a start of the first time window;

herein, the first signal is associated with a first resource set, the first resource set belonging to a first resource pool, the first resource pool including multiple resource sets, any two resource sets included in the first resource pool being associated with a same serving cell.

In one embodiment, at least one spatial parameter of the first signaling is related to at least one of an index of the first resource set in the first resource pool or an index of the first resource pool.

In one embodiment, at least one spatial parameter of the first signaling is associated with an SSB being used to determine a PRACH occasion of the random access preamble included in the first signaling.

In one embodiment, at least one spatial parameter of the first signaling is associated with a Type1-PDCCH CSS set.

In one embodiment, at least one spatial parameter of the first signaling is associated with the first resource set.

In one embodiment, a problem to be solved in the present application includes: how to determine that a spatial parameter used for monitoring a response for a PRACH needs to be enhanced.

In one embodiment, a problem to be solved in the present application includes: how to determine that a spatial parameter used for monitoring a response for a PRACH needs to be enhanced when the UE performs a random access procedure.

In one embodiment, a problem to be solved in the present application includes: when a random access procedure is triggered by a PDCCH order, how to determine that the parameters of the PRACH need to be enhanced.

In one embodiment, a problem to be solved in the present application includes: how to determine a spatial parameter of a PDCCH that is used for monitoring a response for a PRACH transmission.

In one embodiment, a problem to be solved in the present application includes: how to determine a spatial parameter of a PDCCH that is used for monitoring a response for a PRACH, if the UE is configured with multiple TRPs in a cell and transmits a PRACH.

In one embodiment, whether or not a PDCCH used to carry the first signaling has the same quasi co-location properties as a PDCCH used to carry the second signaling is related to at least one of an index of the first resource set in the first resource pool or an index of the first resource pool being configured or indicated.

In one subembodiment, if at least one of the index of the first resource set in the first resource pool or the index of the first resource pool is configured or indicated, the PDCCH used to carry the first signaling has different quasi co-location properties than the PDCCH used to carry the second signaling.

In one subembodiment, if at least one of the index of the first resource set in the first resource pool or the index of the first resource pool is neither configured nor indicated, the PDCCH used to carry the first signaling has the same quasi co-location properties as the PDCCH used to carry the second signaling.

In one embodiment, characteristics of the above method include that a spatial parameter of the PDCCH being used to monitor a response for the PRACH is related to a TRP associated with the PRACH.

In one embodiment, characteristics of the above method include that a random access procedure associated with the first signal is used for uplink synchronization.

In one embodiment, characteristics of the above method include that a random access procedure associated with the first signal is used for Beam Failure Recovery (BFR).

In one embodiment, characteristics of the above method include that a random access procedure associated with the first signal is triggered by the second signaling.

In one embodiment, characteristics of the above method include that a random access procedure associated with the first signal is triggered by the UE.

In one embodiment, an advantage of the above method includes: simplifying the complexity of UE implementation.

According to one aspect of the present application, characterized in comprising:

receiving a second signaling, the second signaling being used to trigger the first signal;

herein, the second signaling is used to determine that the first signal is associated with the first resource set.

In one embodiment, characteristics of the above method include: a random access procedure associated with the first signal being triggered by the second signaling.

In one embodiment, characteristics of the above method include: a random access procedure associated with the first signal being a random access procedure for a PDCCH order.

In one embodiment, characteristics of the above method include that only when the first signal is triggered by the second signaling, at least one spatial parameter of the first signaling is related to at least one of an index of the first resource set in the first resource pool or an index of the first resource pool.

According to one aspect of the present application, characterized in that the index of the first resource pool is an index of at least one Control resource set (CORESET) to which the second signaling belongs.

According to one aspect of the present application, characterized in comprising:

receiving a third signaling, the third signaling indicating a first amount of timing advance;

herein, the third signaling includes the random access response for the first signal.

According to one aspect of the present application, characterized in that at least one spatial parameter of the third signaling is related to at least one spatial parameter of the first signal.

According to one aspect of the present application, characterized in that at least one spatial parameter of the third signaling is related to at least one of an index of the first resource set in the first resource pool or an index of the first resource pool.

According to one aspect of the present application, characterized in comprising:

transmitting a second signal;

herein, the first amount of timing advance is used to determine a transmission time for the second signal; the second signal being associated with the first resource set.

According to one aspect of the present application, characterized in comprising:

starting or restarting a first timer as a response to the first amount of timing advance being received;

herein, the first resource set is associated with the first timer.

According to one aspect of the present application, characterized in comprising:

monitoring a fourth signaling in a second time window, the fourth signaling being used to schedule a random access response for the first signal, an end time in time domain of the first signal being used to determine a start of the first time window;

herein, at least one spatial parameter of the fourth signaling is related to at least one spatial parameter of the second signaling.

The present application provides a method in a second node for wireless communications, comprising:

receiving a first signal, the first signal including at least a random access preamble; and

transmitting a first signaling, the first signaling being used to schedule a random access response for the first signal;

herein, the first signaling is monitored in a first time window, and an end time in time domain of the first signal is used to determine a start of the first time window; the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.

According to one aspect of the present application, characterized in comprising:

transmitting a second signaling, the second signaling being used to trigger the first signal;

herein, the second signaling is used to determine that the first signal is associated with the first resource set.

According to one aspect of the present application, characterized in that the index of the first resource pool is an index of at least one CORESET to which the second signaling belongs.

According to one aspect of the present application, characterized in comprising:

transmitting a third signaling, the third signaling indicating a first amount of timing advance;

herein, the third signaling includes the random access response for the first signal.

According to one aspect of the present application, characterized in that at least one spatial parameter of the third signaling is related to at least one spatial parameter of the first signal.

According to one aspect of the present application, characterized in that at least one spatial parameter of the third signaling is related to at least one of an index of the first resource set in the first resource pool or an index of the first resource pool.

According to one aspect of the present application, characterized in comprising:

receiving a second signal;

herein, the first amount of timing advance is used to determine a transmission time for the second signal; the second signal being associated with the first resource set.

According to one aspect of the present application, characterized in that as a response to the first amount of timing advance being received, the first timer is started or restarted; herein, the first resource set is associated with the first timer.

According to one aspect of the present application, characterized in comprising:

transmitting a fourth signaling, the fourth signaling being used to schedule a random access response for the first signal;

herein, the fourth signaling is monitored in a second time window, and an end time in time domain of the first signal is used to determine a start of the first time window; at least one spatial parameter of the fourth signaling is related to at least one spatial parameter of the second signaling.

The present application provides a first node for wireless communications, comprising:

a first transmitter, transmitting a first signal, the first signal including at least a random access preamble; and

a first receiver, monitoring a first signaling in a first time window, the first signaling being used to schedule a random access response for the first signal, an end time in time domain of the first signal being used to determine a start of the first time window;

herein, the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.

The present application provides a second node for wireless communications, comprising:

a second receiver, receiving a first signal, the first signal including at least a random access preamble; and

a second transmitter, transmitting a first signaling, the first signaling being used to schedule a random access response for the first signal;

herein, the first signaling is monitored in a first time window, and an end time in time domain of the first signal is used to determine a start of the first time window; the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.

In one embodiment, compared with the prior art, the present application is advantageous in the following aspects:
achieving uplink synchronization for a TRP;
avoiding the impact of the uplink synchronization procedure for one TRP on another TRP;
avoiding the impact of a random access procedure performed at one TRP on another TRP;
avoiding the problem of failing to decode the Physical downlink shared channel (PDSCH) corresponding to the C-RNTI due to the conflict between the C-RNTI (i.e., Cell RNTI) and the RA-RNTI (i.e., Random Access RNTI) in the conventional scheme.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmitting a first signal and a first signaling according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to another embodiment of the present application.

FIG. 7 illustrates a flowchart of radio signal transmission according to a third embodiment of the present application.

FIG. 8 illustrates a schematic diagram of an index of a first resource pool being an index of at least one CORESET to which a second signaling belongs according to one embodiment of the present application.

FIG. 9 illustrates a schematic diagram of at least one spatial parameter of a third signaling relating to at least one spatial parameter of a first signal according to one embodiment of the present application.

FIG. 10 illustrates a schematic diagram of at least one spatial parameter of a third signaling relating to at least one of an index of a first resource set in a first resource pool or an index of a first resource pool according to one embodiment of the present application.

FIG. 11 illustrates a flowchart of radio signal transmission according to a fourth embodiment of the present application.

FIG. 12 illustrates a structure block diagram of a processing device used in a first node according to one embodiment of the present application.

FIG. 13 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

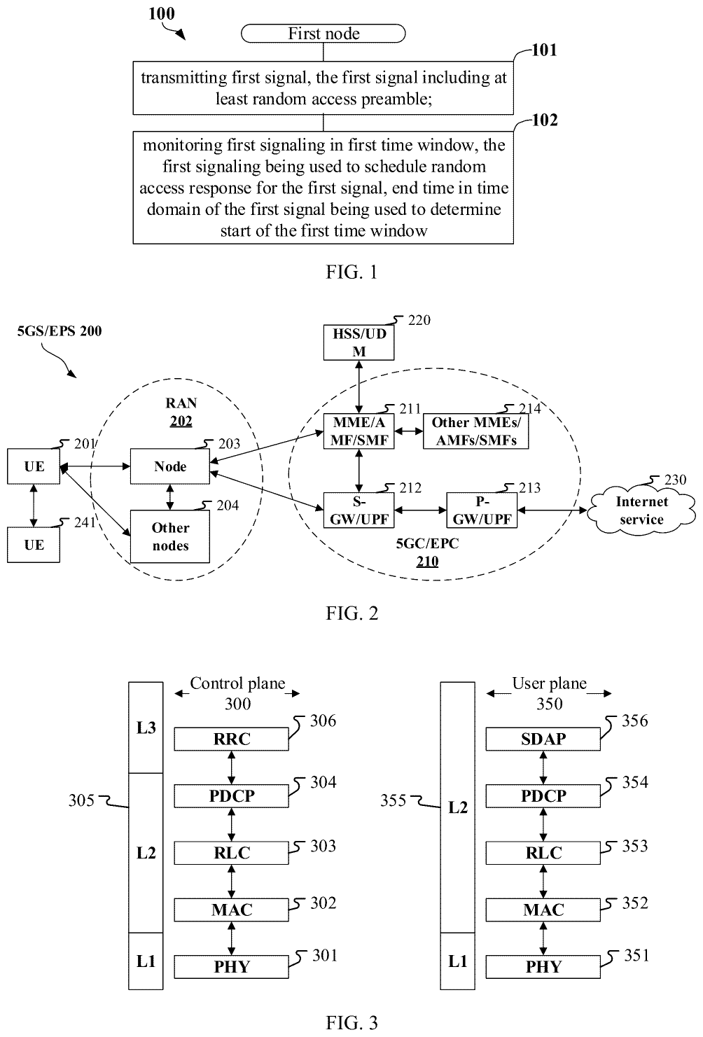

Embodiment 1 illustrates a flowchart of transmitting a first signal and a first signaling according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application transmits a first signal in step 101, the first signal including at least a random access preamble; and monitors a first signaling in a first time window in step 102, the first signaling being used to schedule a random access response for the first signal, an end time in time domain of the first signal being used to determine a start of the first time window; herein, the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.

In one embodiment, a first SSB (i.e., Synchronization Signal Block) is associated with a random access preamble in the first signal.

In one embodiment, an SSB comprises an SS/PBCH (i.e., Physical Broadcast Channel) block.

In one embodiment, at least a first SSB is used to determine a PRACH occasion of the random access preamble included in the first signal.

In one embodiment, an index of a first SSB and an index of a PRACH Mask are used to determine a PRACH occasion of the random access preamble included in the first signal.

In one embodiment, the PRACH occasion of the random access preamble included in the first signal is determined via lookup in table based on an index of the first SSB and an index of the PRACH Mask.

In one embodiment, the PRACH occasion of the random access preamble included in the first signal is determined via lookup in table in Section 7.4 of 3GPP TS38.321 based on an index of the first SSB and an index of the PRACH Mask.

In one embodiment, the first SSB belonging to the first resource set is used to determine that the first SSB is associated with the first resource set.

In one embodiment, the first SSB belonging to the first resource set is indicated by a DCI (i.e., Downlink Control Information).

In one embodiment, the first SSB belonging to the first resource set is indicated by a Radio Resource Control (RRC) Message.

In one embodiment, the first SSB belonging to the first resource set is indicated by the second signaling. In one embodiment, the first SSB belonging to the first resource set is pre-configured.

In one embodiment, the first SSB belonging to the first resource set is predefined.

In one embodiment, that an index of the first SSB is an index of an SSB in the first resource set is used to determine that the first SSB belongs to the first resource set.

In one embodiment, the first node selects the first SSB based on Reference signal received power (RSRP).

In one embodiment, the first node selects the first SSB based on SS-RSRP.

In one embodiment, an RRC message is used to configure an index of a PRACH mask.

In one embodiment, the second signaling in this application indicates an index of the first SSB and an index of the PRACH mask.

In one embodiment, the first signal is transmitted according to the PRACH occasion of the random access preamble included in the first signal.

In one embodiment, a receiver of the first signal includes the first sub-node.

In one embodiment, the first signal is received by the first sub-node.

In one embodiment, the receiver of the first signal includes a TRP in a Special Cell (SpCell).

In one embodiment, the first signal is received by one TRP in a SpCell.

In one embodiment, the receiver of the first signal includes all or part of maintenance base stations of the first cell.

In one embodiment, the receiver of the first signal includes all or part of maintenance base stations of the second cell.

In one embodiment, the second cell is the first cell.

In one subembodiment, the first cell is the second cell.

In one subembodiment, the first cell is the SpCell.

In one subembodiment, the first cell is a Primary Cell (PCell).

In one subembodiment, the first cell is a Primary SCG (i.e., Secondary Cell Group) Cell (PSCell).

In one embodiment, the second cell is a mobility management cell for the first cell.

In one subembodiment, the first cell has a different physical cell identity (PCI) from the second cell.

In one subembodiment, the second cell provides additional wireless resources to the first cell.

In one subembodiment, the first cell is configured with a ServCellIndex and the second cell is not configured with a ServCellIndex.

In one subembodiment, the first cell and the second cell are configured with the same ServCellIndex.

In one subembodiment, the first cell is configured with a ServCellIndex and the second cell is associated with a ServCellIndex of the first cell.

In one subembodiment, the first cell is neither an SCell nor a SpCell and the second cell is an SCell or a SpCell.

In one subembodiment, the first cell is configured with at least one SSB of the second cell.

In one subembodiment, the first node is configured with one SSB in the first cell, the one SSB being configured by a CSI-SSB-ResourceSet IE, the CSI-SSB-ResourceSet IE comprising an RRC field, the RRC field being used to indicate that the one SSB belongs to the second cell.

In one subembodiment, the RRC field is set to a cell identity of the second cell.

In one subembodiment, the RRC field is set to a PCI of the second cell.

In one subembodiment, the name of the RRC field includes additionalPCI.

In one subembodiment, the name of the RRC field includes additionalPCIIndex.

In one embodiment, the first signal is a PRACH transmission.

In one embodiment, the first signal is an uplink signal of a first random access procedure.

In one embodiment, the first signal is a Message 1 (Msg1) of a first random access procedure.

In one embodiment, the first signal is a Message A (MsgA) of a first random access procedure.

In one embodiment, the first random access procedure is a Contention-Based Random Access (CBRA) procedure.

In one embodiment, the first random access procedure is a Contention-free Random Access (CFRA) procedure.

In one embodiment, the first random access procedure is used for uplink synchronization.

In one embodiment, the first random access procedure is used for uplink synchronization for a TAG to which the first resource set in the first resource pool belongs.

In one embodiment, the first random access procedure is used for BFR.

In one embodiment, the first random access procedure is used for BFR for the first resource set in the first resource pool.

In one embodiment, the first random access procedure is triggered by the second signaling in this application.

In one embodiment, the first random access procedure is triggered by a UE.

In one embodiment, the first signal is a random access preamble.

In one embodiment, the first signal comprises at least one random access preamble.

In one embodiment, the first signal comprises a random access preamble.

In one embodiment, the first signal comprises only one random access preamble.

In one embodiment, the first signal is Message 1 (Msg1).

In one embodiment, the first signal is Message A (MSGA).

In one subembodiment, the MSGA includes the random access preamble and PUSCH transmission.

In one subembodiment, the MSGA includes the random access preamble and at least one C-RNTI Medium Access Control (MAC) Control Element (CE), the C-RNTI MAC CE including a C-RNTI of the first node in the first cell; the receiver of the first signal is a TRP of a maintenance base station for the first cell.

In one subembodiment, the MSGA includes the random access preamble and at least one C-RNTI MAC CE, the C-RNTI MAC CE including a C-RNTI of the first node in the second cell; the receiver of the first signal is a TRP of a maintenance base station for the second cell.

In one subembodiment, the MSGA includes the random access preamble and at least one Common Control Channel (CCCH) Service Data Unit (SDU).

In one embodiment, the first signal comprises a random access preamble and a PUSCH transmission.

In one embodiment, the first signal comprises a random access preamble and at least one MAC subheader.

In one embodiment, the first signal comprises a random access preamble and at least one MAC Protocol Data Unit (PDU).

In one embodiment, the first signal comprises a random access preamble and at least one C-RNTI MAC CE.

In one embodiment, the first signal comprises a random access preamble and at least one CCCH SDU.

In one embodiment, the random access preamble in the first signal is explicitly indicated by a PDCCH order.

In one embodiment, the random access preamble in the first signal is configured via an RRC message.

In one embodiment, the random access preamble in the first signal is selected by the UE according to RSRP.

In one embodiment, an index of the random access preamble in the first signal is explicitly indicated by a DCI field and the index of the random access preamble is not 0b000000.

In one subembodiment, the DCI field is a Random Access Preamble index field.

In one subembodiment, the DCI field is a field in the second signaling of this application.

In one subembodiment, the index of the random access preamble comprises a ra-PreambleIndex.

In one embodiment, the random access preamble in the first signal comprises a bit string.

In one embodiment, the random access preamble in the first signal comprises a characteristic sequence.

In one embodiment, as a response to the first time window expiring and the first signaling not being

successfully received, adding 1 to PREAMBLE_TRANSMISSION_COUNTER.

In one subembodiment, if the PREAMBLE_TRANSMISSION_COUNTER that is being added by 1 is equal to preambleTransMax+1, indicating to a higher layer a random access problem.

In one subembodiment, if the PREAMBLE_TRANSMISSION_COUNTER that is being added by 1 is equal to preambleTransMax+1, indicating to a higher layer a random access problem.

In one embodiment, as a response to the first time window expiring and the first signaling not being successfully received, a random backoff time is selected according to a uniform distribution between 0 and PREAMBLE_BACKOFF.

In one embodiment, as a response to the first time window expiring and the first signaling not being successfully received, a random access resource selection procedure is performed.

In one embodiment, as a response to the first time window expiring and the first signaling not being successfully received, a random access preamble is retransmitted, the random access preamble being the same as the random access preamble in the first signal.

In one embodiment, as a response to the first time window expiring and the first signaling not being successfully received, a random access preamble is retransmitted, the random access preamble being different from the random access preamble in the first signal.

In one embodiment, the first signaling is received; the first time window has not expired when the first signaling is received.

In one embodiment, the first signaling is not received; the first time window expires.

In one embodiment, the first signaling is a physical layer signaling.

In one embodiment, the first signaling is used for scheduling a PDSCH.

In one embodiment, the first signaling is downlink control information.

In one embodiment, the first signaling is a DCI.

In one embodiment, the first signaling comprises a DCI format 1_0.

In one embodiment, the first signaling comprises a DCI format 1_1.

In one embodiment, the first signaling comprises a DCI format 1_2.

In one embodiment, a Cyclic Redundancy Check (CRC) of the first signaling is scrambled by a C-RNTI.

In one embodiment, the CRC of the first signaling is scrambled by a RA-RNTI.

In one embodiment, the CRC of the first signaling is scrambled by a MSGA-RNTI.

In one embodiment, the first signaling is used to indicate physical layer scheduling information for RAR.

In one embodiment, the first signaling is used to indicate an amount of timing advance.

In one embodiment, the first signaling is in a format of DCI format 1_0, and the CRC of the first signaling is scrambled by a RA-RNTI.

In one embodiment, the first signaling is in a format of DCI format 1_0, and the CRC of the first signaling is scrambled by a C-RNTI or a Configured Scheduling RNTI (CS-RNTI) or a Modulation and Coding Scheme RNTI (MCS-RNTI).

In one embodiment, the first signaling is in a format of DCI format 1_0, and the CRC of the first signaling is scrambled by a MSGB-RNTI.

In one embodiment, the first signal is used to trigger the first signaling.

In one embodiment, receiving the first signaling as a response to the first signal being transmitted.

In one embodiment, monitoring the first signaling as a response to the first signal being transmitted.

In one embodiment, the action of monitoring a first signaling in a first time window includes: monitoring the first signaling during the time while the first time window is running.

In one embodiment, the action of monitoring a first signaling in a first time window includes: monitoring the first signaling only when the first time window is running.

In one embodiment, monitoring the first signaling by monitoring a PDCCH of a random access response for the first signal; the PDCCH being identified by either a C-RNTI or a RA-RNTI.

In one embodiment, monitoring the first signaling by monitoring a PDCCH of a random access response for the first signal; the PDCCH being identified by a C-RNTI.

In one embodiment, monitoring the first signaling by monitoring a PDCCH of a random access response for the first signal; the PDCCH being identified by a RA-RNTI.

In one embodiment, monitoring the first signaling by monitoring a PDCCH of a random access response for the first signal; the PDCCH being identified by a RA-RNTI.

In one embodiment, monitoring the first signaling by monitoring a PDCCH of a random access response for the first signal; the PDCCH being identified by a MSGB-RNTI.

In one embodiment, the action of monitoring the first signaling comprises: determining whether the first signaling exists.

In one embodiment, the action of monitoring the first signaling comprises: detecting the first signaling.

In one embodiment, the action of monitoring the first signaling comprises: monitoring the first signaling.

In one embodiment, the action of monitoring the first signaling comprises: determining whether the first signaling exists through CRC check.

In one embodiment, the action of monitoring the first signaling comprises: determining whether the first signaling exists through energy detection.

In one embodiment, the action of monitoring the first signaling comprises: determining whether the first signaling exists through maximum likelihood detection.

In one embodiment, a name of the first time window includes ra-Response Window.

In one embodiment, the first time window is a ra-Response Window.

In one embodiment, a name of the first time window includes ra-ResponseWindow.

In one embodiment, the first time window comprises at least one symbol.

In one embodiment, the first time window is configured via an RRC message.

In one embodiment, the first time window is configured in RACH-ConfigCommon.

In one embodiment, the length of the first time window comprises a positive integer number of slot(s).

In one embodiment, the length of the first time window is pre-configured.

In one embodiment, the length of the first time window is configurable.

In one embodiment, the phrase an end time in time domain of the first signal being used to determine a start of the first time window comprises: at least the end time in time domain of the first signal being used to determine the start of the first time window.

In one embodiment, the phrase an end time in time domain of the first signal being used to determine a start of the first time window comprises: the start of the first time window being related to the end time in time domain of the first signal.

In one embodiment, the phrase an end time in time domain of the first signal being used to determine a start of the first time window comprises: the start of the first time window being related to at least the end time in time domain of the first signal.

In one embodiment, the first time window is started at a first PDCCH occasion after the first signal has been transmitted.

In one embodiment, a start of the first time window is the time at which the first time window is started.

In one embodiment, a start of the first time window is the time at which the first time window starts running.

In one embodiment, the end time in time domain of the first signal is the time at which a last symbol of the first signal has been transmitted.

In one embodiment, the end time in time domain of the first signal is a first slot after the first signal has been transmitted

In one embodiment, the end time in time domain of the first signal is a slot in which a last symbol of the first signal has been transmitted.

In one embodiment, the phrase an end time in time domain of the first signal being used to determine a start of the first time window comprises: the end time in time domain of the first signal being used to determine starting of the first time window.

In one embodiment, the phrase an end time in time domain of the first signal being used to determine a start of the first time window comprises: the start of the first time window being related to the end time in time domain of the first signal.

In one embodiment, the phrase an end time in time domain of the first signal being used to determine a start of the first time window comprises: a first PDCCH occasion after the end time in time domain of the first signal is the start of the first time window; the first signal includes only a random access preamble.

In one embodiment, the phrase an end time in time domain of the first signal being used to determine a start of the first time window comprises: a K1-th slot after the end time in time domain of the first signal is the start of the first time window.

In one embodiment, the first time window is started according to an end time in time domain of the first signal.

In one embodiment, the first time window is started at least after an end time in time domain of the first signal.

In one embodiment, the first time window is started at a K1-th slot after an end time in time domain of the first signal.

In one embodiment, the first time window is started at a first PDCCH occasion after an end time in time domain of the first signal; the first signal including only a random access preamble.

In one embodiment, once a random access preamble in the first signal has been transmitted, ignoring any possible measurement intervals, and at a first PDCCH occasion after an end time in time domain of the first signal, a MAC entity starts the first time window; the first signal including only a random access preamble.

In one embodiment, one system message is used to determine a length of the first time window.

In one subembodiment, the one system message comprises an RRC message.

In one subembodiment, the one system message comprises a System Information Block (SIB) message.

In one subembodiment, the one system message is a SIB1 message.

In one subembodiment, the one system message is transmitted via a Broadcast Control Channel (BCCH).

In one embodiment, an end time in time domain of the first signal and a given Common search space (CSS) are used to determine a start of the first time window.

In one embodiment, the given CSS is a CSS.

In one embodiment, the given CSS is a Type1-PDCCH CSS set.

In one embodiment, the given CSS is used to determine monitoring of the first signaling.

In one embodiment, the phrase an end time in time domain of the first signal and a given CSS are used to determine a start of the first time window comprises: the first node determining the start of the first time window based on the end time in time domain of the first signal and the given CSS.

In one embodiment, the phrase an end time in time domain of the first signal and a given CSS are used to determine a start of the first time window comprises: the start of the first time window being related to both the end time in time domain of the first signal and the given CSS.

In one embodiment, the phrase an end time in time domain of the first signal and a given CSS are used to determine a start of the first time window comprises: the start of the first time window being related to both the end time in time domain of the first signal and the given CSS.

In one embodiment, the phrase an end time in time domain of the first signal and a given CSS are used to determine a start of the first time window comprises: at a first symbol of an earliest CORESET of the given CSS used for monitoring the first signaling that the first node is configured with, which is after a last symbol of the PRACH occasion for the random access preamble in the first signal, starting the first time window. In one embodiment, the phrase an end time in time domain of the first signal and a given CSS are used

to determine a start of the first time window comprises: after a last symbol of the PRACH occasion for the random access preamble in the first signal, at a first symbol of an earliest CORESET of the given CSS used for monitoring the first signaling that the first node is configured with, starting the first time window.

In one embodiment, the phrase of the first signaling being used to schedule a random access response for the first signal comprises: the first signaling being used to schedule the third signaling in this application; the third signaling in this application being the random access response for the first signal.

In one embodiment, the phrase of the first signaling being used to schedule a random access response for the first signal comprises: the first signaling being used to determine physical layer scheduling information for a PDSCH, the PDSCH being used to carry at least the random access response for the first signal.

In one embodiment, the phrase of the first signaling being used to schedule a random access response for the first signal comprises: the first signaling indicating physical layer scheduling information for the random access response for the first signal.

In one embodiment, the physical layer scheduling information comprises at least one of Frequency domain resource assignment, or Time domain resource assignment, or Virtual resource block-to-Physical resource block (VRB-to-PRB) mapping, or a Modulation and coding scheme (MCS), or a New data indicator (NDI), or a Redundancy version (RV), or, a Hybrid automatic repeat request (HARQ) process number.

In one embodiment, the phrase of the first signaling being used to schedule a random access response for the first signal comprises: the first signaling comprising the random access response for the first signal.

In one embodiment, the phrase of the first signaling being used to schedule a random access response for the first signal comprises: the first signaling carrying the random access response for the first signal.

In one embodiment, the phrase of the first signaling being used to schedule a random access response for the first signal comprises: the first signaling indicating the random access response for the first signal.

In one embodiment, the phrase of the first signaling being used to schedule a random access response for the first signal comprises: the first signaling being the random access response for the first signal.

In one embodiment, the random access response for the first signal is a MAC RAR.

In one embodiment, the random access response for the first signal is a DCI.

In one embodiment, the random access response for the first signal is a MAC layer signaling.

In one embodiment, the random access response for the first signal is a physical layer signaling.

In one embodiment, the random access response for the first signal comprises a MAC CE.

In one embodiment, the random access response for the first signal comprises a MSGB.

In one embodiment, the random access response for the first signal comprises a MAC RAR.

In one embodiment, the random access response for the first signal comprises a fallbackRAR.

In one embodiment, the phrase that the first signal is associated with the first resource set includes that the first signal is determined based on the first resource set.

In one embodiment, the phrase that the first signal is associated with the first resource set includes that transmission parameters of the first signal are related to the first resource set.

In one embodiment, the phrase that the first signal is associated with the first resource set includes that a TRP to which an antenna port used for transmitting the first signal belongs is the same as a TRP to which the first resource set belongs.

In one embodiment, the phrase that the first signal is associated with the first resource set includes that an SSB corresponding to the first signal belongs to the first resource set.

In one embodiment, the phrase that the first signal is associated with the first resource set includes that an SSB corresponding to the first signal is an SSB in the first resource set.

In one embodiment, the phrase that the first signal is associated with the first resource set includes that the first SSB is associated with the first resource set.

In one embodiment, any resource set in the first resource pool is associated with a TRP.

In one embodiment, any resource set in the first resource pool includes at least one SSB.

In one embodiment, any resource set in the first resource pool includes at least one PRACH occasion.

In one embodiment, the same cell is a SpCell.

In one embodiment, the same cell is a PCell.

In one embodiment, the same cell is a PSCell.

In one embodiment, the first resource pool includes at least 2 resource sets.

Typically, the first resource pool includes only 2 resource sets.

In one embodiment, the first resource pool includes a master Primary Timing Advance Group (PTAG) and a secondary PTAG, the first resource set being any one of the master PTAG or the secondary PTAG.

In one subembodiment, the first resource pool includes a master PTAG and a secondary PTAG, the first resource set being the master PTAG of the master PTAG or the secondary PTAG.

In one subembodiment, the first resource pool includes a master PTAG and a secondary PTAG, the first resource set being the secondary PTAG of the master PTAG or the secondary PTAG.

In one subembodiment, a name of the master PTAG includes at least one of PTAG, or M, or m, or -.

In one subembodiment, a name of the master PTAG is MPTAG, or mPTAG, or M-PTAG, or m-PTAG.

In one subembodiment, a name of the secondary PTAG includes at least one of PTAG, or S, or s, or -.

In one subembodiment, a name of the secondary PTAG is SPTAG, or PTAG, or S-PTAG, or s-PTAG.

In one embodiment, any resource set in the first resource pool is a TRP, and the first resource set is a TRP in the first resource pool.

In one subembodiment, the first resource pool includes a primary TRP and a secondary TRP, the first resource set being any one of the primary TRP or the secondary TRP.

In one subembodiment, the first resource pool includes a primary TRP and a secondary TRP, the first resource set being the primary TRP of the primary TRP or the secondary TRP.

In one subembodiment, the first resource pool includes a primary TRP and a secondary TRP, the first resource set being the secondary TRP of the primary TRP or the secondary TRP.

In one subembodiment, a name of the primary TRP includes at least one of TRP, or M, or m, or -.

In one subembodiment, a name of the primary TRP is MTRP, or mTRP, or M-TRP, or m-TRP.

In one subembodiment, a name of the secondary TRP includes at least one of TRP, or S, or s, or -.

In one subembodiment, a name of the secondary TRP is STRP, or sTRP, or S-TRP, or s-TRP.

In one embodiment, the first resource pool includes at least two resource sets.

In one embodiment, an antenna port corresponding to one resource set in the first resource pool is different from an antenna port corresponding to another resource set in the first resource pool.

In one embodiment, an uplink transmission timing corresponding to one resource set in the first resource pool is different from an uplink transmission timing corresponding to another resource set in the first resource pool.

In one embodiment, a Timing Advance (TA) corresponding to one resource set in the first resource pool is different from a TA corresponding to another resource set in the first resource pool.

In one embodiment, any two resource sets included in the first resource pool belong to a same serving cell.

In one embodiment, any two resource sets included in the first resource pool include at least part of a same serving cell.

In one embodiment, any two resource sets included in the first resource pool are configured for a same serving cell.

In one embodiment, any two resource sets included in the first resource pool each include a TRP of the same serving cell.

In one embodiment, any two resource sets included in the first resource pool are each associated with a TRP of the same serving cell.

In one embodiment, the first resource pool comprises the first resource set and the second resource set, the first resource set being associated with the first cell, and the second resource set being associated with the second cell, the second cell being associated with the first cell.

In one embodiment, the first resource set belongs to the first cell, while the second resource set belongs to the second cell.

In one embodiment, any resource set in the first resource pool is associated with the first cell.

In one embodiment, the first resource pool comprises two resource sets, the first resource set being associated with the first cell, and the second resource set being associated with the second cell.

In one embodiment, the multiple resource sets included in the first resource pool are all associated with the first cell.

In one embodiment, the first resource pool is a cell and the first resource set is a TRP in the cell.

In one embodiment, the first resource set is associated with a TRP.

In one embodiment, the first resource set is associated with a reference signal set.

In one embodiment, the first resource set is associated with a CORESET.

In one embodiment, the first resource set is associated with a subset of a CORESET.

In one embodiment, the first resource set is a resource set in the first resource pool.

In one embodiment, the first resource set is a first resource set among the multiple resource sets in the first resource pool.

In one embodiment, the multiple resource sets include at least 2 resource sets.

In one embodiment, the multiple resource sets include more than 2 resource sets.

In one embodiment, the multiple resource sets are 2 resource sets.

In one embodiment, the first resource pool comprises at least one Reference Signal (RS) resource, and any resource set in the first resource pool comprises at least one of the at least one RS resource.

In one subembodiment, each RS resource in the first resource pool comprises a downlink RS resource.

In one subembodiment, each RS resource in the first resource pool comprises an SSB.

In one subembodiment, each RS resource in the first resource pool comprises an SS/PBCH Block.

In one subembodiment, each RS resource in the first resource pool comprises a CSI-RS resource.

In one subembodiment, each RS resource in the first resource pool comprises an SSB indexed by an SSB-Index.

In one subembodiment, each RS resource in the first resource pool is an SSB indexed by an SSB-Index.

In one subembodiment, each RS resource in the first resource pool comprises an SSB indexed by a CSI-SSB-ResourceSetId.

In one subembodiment, each RS resource in the first resource pool is an SSB indexed by a CSI-SSB-ResourceSetId.

In one subembodiment, each RS resource in the first resource pool comprises a CSI-RS indexed by csi-RS-Index.

In one subembodiment, each RS resource in the first resource pool is a CSI-RS indexed by a csi-RS-Index.

In one subembodiment, each RS resource in the first resource pool comprises an uplink RS resource.

In one subembodiment, each RS resource in the first resource pool comprises a PUCCH resource.

In one subembodiment, any SSB in one RS resource set in the first resource pool is different from any SSB in another RS resource set in the first resource pool; each RS resource in the first resource pool comprises an SSB.

In one subembodiment, an index of any SSB in one RS resource set in the first resource pool is different from an index of any SSB in another RS resource set in the first resource pool; each RS resource in the first resource pool comprises an SSB.

In one subembodiment, an index of one SSB in one RS resource set in the first resource pool is the same as an index of any SSB in another RS resource set in the first resource pool; each RS resource in the first resource pool comprises an SSB.

In one embodiment, the first resource pool comprises a first resource set and a second resource set, the first resource pool comprises Q RS resources, the first resource set comprises Q1 RS resources, and the second resource set comprises Q2 RS resources, Q being equal to the sum of Q1 and Q2.

In one subembodiment, Q is no greater than 64, Q1 is no greater than 32, and Q2 is no greater than 32.

In one subembodiment, Q is no greater than 128, Q1 is no greater than 64, and Q2 is no greater than 64.

In one subembodiment, Q is a positive integer.

In one subembodiment, Q is no greater than 64.

In one subembodiment, Q is no greater than 128.

In one subembodiment, Q1 is a positive integer and Q1 is less than Q; Q2 is a positive integer and Q2 is less than Q.

In one subembodiment, Q is configurable.

In one subembodiment, Q1 and Q2 are configurable.

In one subembodiment, an index of an RS resource in the first resource pool is used to determine a resource set to which the RS resource belongs.

In one subembodiment, the second signaling is used to determine a resource set to which the RS resource belongs.

In one subembodiment, the second signaling is used to determine that the first SSB is associated with the first resource set; the first SSB is an SSB in the first resource pool.

In one subembodiment, an index of the first SSB is used to determine that the first SSB is associated with the first resource set; the first SSB is an SSB in the first resource pool.

In one subembodiment, an index of any of the Q1 RS resources is different from an index of any of the Q2 RS resources.

In one subembodiment, an index of any of the Q1 RS resources in the first resource set is not less than 0 and not greater than 31; and an index of any of the Q2 RS resources in the second resource set is not less than 32 and not greater than 63.

In one subembodiment, an index of any of the Q1 RS resources in the first resource set is not less than 32 and not greater than 63; and an index of any of the Q2 RS resources in the second resource set is not less than 0 and not greater than 31.

In one subembodiment, there is one RS resource among the Q1 RS resources of which an index is the same as an index of one RS resource among the Q2 RS resources.

In one subembodiment, an index of any of the Q1 RS resources in the first resource set is not less than 0 and not greater than 63; and an index of any of the Q2 RS resources in the second resource set is not less than 0 and not greater than 63.

In one embodiment, the at least one spatial parameter includes only one spatial parameter.

In one embodiment, the at least one spatial parameter includes more than one spatial parameter.

In one embodiment, the spatial parameter is used to determine differences in channel large-scale parameters due to variations in the analog beamforming.

In one embodiment, the spatial parameter is configured via an RRC message.

In one embodiment, the spatial parameter is predefined.

In one embodiment, the spatial parameter is pre-configured.

In one embodiment, the spatial parameter comprises: Transmission Configuration Indicator (TCI).

In one embodiment, the spatial parameter comprises: Quasi co-location (QCL).

In one embodiment, the spatial parameter comprises: QCL type.

In one embodiment, the spatial parameter comprises: spatial filter.

In one embodiment, the spatial parameter comprises: spatial RX parameter(s).

In one embodiment, the spatial parameter comprises: quasi-co-location (QCL) parameter(s).

In one embodiment, the spatial parameter comprises: quasi co-location properties.

In one embodiment, the spatial parameter comprises: antenna port quasi co-location properties.

In one embodiment, the spatial parameter comprises: large-scale parameter.

In one embodiment, the spatial parameter comprises: channel correlation matrix.

In one embodiment, the spatial parameter comprises: transmitting beam.

In one embodiment, the spatial parameter comprises: receiving beam.

In one embodiment, the spatial parameter comprises: transmitting/receiving beam pair.

In one embodiment, the spatial parameter is spatial RX parameter(s).

In one embodiment, the spatial parameter is spatial reception parameter(s).

In one embodiment, the spatial parameter includes: at least one of a large-scale parameter channel, or a correlation matrix, or a transmitting beam, or a receiving beam or a transmitting/receiving beam pair.

In one embodiment, the antenna port quasi co-location properties include Demodulation Reference Signal (DM-RS) antenna port quasi co-location properties.

In one embodiment, the antenna port quasi co-location properties are DM-RS antenna port quasi co-location properties.

In one embodiment, in instances when channel properties of a symbol on a certain antenna port can be deduced from those on another antenna port, it is considered that these two ports are QCL.

In one embodiment, the QCL type includes QCL-Type A.

In one embodiment, the QCL type includes QCL-Type B.

In one embodiment, the QCL type includes QCL-Type C.

In one embodiment, the QCL type includes QCL-Type D.

In one embodiment, the first node assumes that at least one spatial parameter of the first signaling is related to at least one of an index of the first resource set in the first resource pool or an index of the first resource pool.

In one embodiment, the sentence “at least one spatial parameter of the first signaling is related to at least one of an index of the first resource set in the first resource pool or an index of the first resource pool” includes: at least one spatial parameter of the first signaling being related to the first SSB.

In one embodiment, the sentence “at least one spatial parameter of the first signaling is related to at least one of an index of the first resource set in the first resource pool or an index of the first resource pool” includes: determining at least one spatial parameter of the first signaling according to at least one of an index of the first resource set in the first resource pool or an index of the first resource pool.

In one embodiment, the sentence “at least one spatial parameter of the first signaling is related to at least one of an index of the first resource set in the first resource pool or an index of the first resource pool” includes: one spatial parameter of the first signaling being related to at least one of an index of the first resource set in the first resource pool or an index of the first resource pool; the one spatial parameter refers to the antenna port quasi co-location properties.

In one embodiment, the sentence “at least one spatial parameter of the first signaling is related to at least one of an index of the first resource set in the first resource pool or an index of the first resource pool” includes: at least one spatial parameter of the first signaling being related to an index of the first resource set in the first resource pool.

In one embodiment, the sentence “at least one spatial parameter of the first signaling is related to at least one of an index of the first resource set in the first resource pool or an index of the first resource pool” includes: at least one spatial parameter of the first signaling being related to an index of the first resource pool.

In one embodiment, the sentence “at least one spatial parameter of the first signaling is related to at least one of an index of the first resource set in the first resource pool or an index of the first resource pool” includes: at least one spatial parameter of the first signaling being related to both an index of the first resource set in the first resource pool and an index of the first resource pool.

In one embodiment, the sentence “at least one spatial parameter of the first signaling is related to at least one of an index of the first resource set in the first resource pool or an index of the first resource pool” includes: at least one of an index of the first resource set in the first resource pool or an index of the first resource pool being used to determine at least one spatial parameter of the first signaling.

In one embodiment, the sentence “at least one spatial parameter of the first signaling is related to at least one of an index of the first resource set in the first resource pool or an index of the first resource pool” includes: at least one of an index of the first resource set in the first resource pool or an index of the first resource pool being used to determine one spatial parameter of the first signaling: the one spatial parameter refers to the antenna port quasi co-location properties.

In one embodiment, the sentence “at least one spatial parameter of the first signaling is related to at least one of an index of the first resource set in the first resource pool or an index of the first resource pool” includes: at least one spatial parameter of the first signaling being related to the first resource set.

In one embodiment, the sentence “at least one spatial parameter of the first signaling is related to at least one of an index of the first resource set in the first resource pool or an index of the first resource pool” includes: at least one spatial parameter of the first signaling being related to the first resource set and the first resource pool.

In one embodiment, the sentence “at least one spatial parameter of the first signaling is related to at least one of an index of the first resource set in the first resource pool or an index of the first resource pool” includes: at least one spatial parameter of the first signaling being related to the first resource pool.

In one embodiment, the sentence “at least one spatial parameter of the first signaling is related to at least one of an index of the first resource set in the first resource pool or an index of the first resource pool” includes: at least one of an index of the first resource set in the first resource pool or an index of the first resource pool being configured or indicated being used to determine that at least one spatial parameter of the first signaling is associated with a Type1-PDCCH CSS set.

In one subembodiment, if at least one of the index of the first resource set in the first resource pool or the index of the first resource pool is neither configured nor indicated, at least one spatial parameter of the first signaling is the same as at least one spatial parameter of the second signaling in this application.

In one embodiment, the sentence “at least one spatial parameter of the first signaling is related to at least one of an index of the first resource set in the first resource pool or an index of the first resource pool” includes: at least one of an index of the first resource set in the first resource pool or an index of the first resource pool being configured or indicated being used to determine that at least one spatial parameter of the first signaling is different from at least one spatial parameter of the second signaling.

In one subembodiment, if at least one of the index of the first resource set in the first resource pool or the index of the first resource pool is neither configured nor indicated, at least one spatial parameter of the first signaling is the same as at least one spatial parameter of the second signaling in this application.

In one embodiment, the sentence “at least one spatial parameter of the first signaling is related to at least one of an index of the first resource set in the first resource pool or an index of the first resource pool” includes: at least one of an index of the first resource set in the first resource pool or an index of the first resource pool being configured or indicated being used to determine that at least one spatial parameter of the first signaling is associated with the first SSB.

In one subembodiment, if at least one of the index of the first resource set in the first resource pool or the index of the first resource pool is neither configured nor indicated, at least one spatial parameter of the first signaling is the same as at least one spatial parameter of the second signaling in this application.

In one embodiment, at least one spatial parameter of the first signaling is associated with a Type1-PDCCH CSS set.

In one subembodiment, antenna port quasi co-location properties of the first signaling are associated with a Type1-PDCCH CSS set.

In one subembodiment, the phrase that antenna port quasi co-location properties of the first signaling are associated with a Type1-PDCCH CSS set includes that the Type1-PDCCH CSS set is used to receive the first signaling.

In one subembodiment, the phrase that antenna port quasi co-location properties of the first signaling are associated with a Type1-PDCCH CSS set includes that the Type1-PDCCH CSS set is used to monitor the first signaling.

In one subembodiment, the Type1-PDCCH CSS set is used to determine antenna port quasi co-location properties of the first signaling.

In one subembodiment, the Type1-PDCCH CSS set is configured by a ra-SearchSpace field in an RRC IE that includes PDCCH-ConfigCommon in its name.

In one subembodiment, the Type1-PDCCH CSS set is associated with a SearchSpaceId.

In one subembodiment, the Type1-PDCCH CSS set is a search space set.

In one subembodiment, the Type1-PDCCH CSS set is associated with a PCell.

In one subembodiment, the Type1-PDCCH CSS set is associated with a CORESET indicated by a ControlResourceSetId.

In one subembodiment, the Type1-PDCCH CSS set is associated with a ControlResourceSet.

In one embodiment, at least one spatial parameter of the first signaling is associated with the first SSB.

In one subembodiment, at least one spatial parameter of the first signaling is related to at least one spatial parameter of the first SSB.

In one subembodiment, at least one spatial parameter of the first signaling is the same as at least one spatial parameter of the first SSB.

In one subembodiment, antenna port quasi co-location properties of the first signaling are associated with the first SSB.

In one subembodiment, the antenna port quasi co-location properties of the first signaling and the antenna port quasi co-location properties of the first SSB are identical.

In one subembodiment, the first SSB is used for receiving the first signaling.

In one subembodiment, the first SSB is used for monitoring the first signaling.

In one subembodiment, the first signaling is received based on the spatial parameter of the first SSB.

In one subembodiment, the first signaling is monitored based on the spatial parameter of the first SSB.

In one embodiment, at least one spatial parameter of the first signaling is associated with the first resource set.

In one subembodiment, the first resource set is used for receiving the first signaling.

In one subembodiment, the first resource set is used for monitoring the first signaling.

In one subembodiment, the first resource set is used to determine antenna port quasi co-location properties of the first signaling.

In one subembodiment, the first resource set is configured by a ra-SearchSpace field in an RRC IE that includes PDCCH-ConfigCommon in its name.

In one subembodiment, the first resource set is associated with a SearchSpaceId.

In one subembodiment, the first resource set is a search space set, and the search space set is associated with the first resource pool.

In one subembodiment, the first resource set is associated with a PCell.

In one subembodiment, the first resource set is a search space, and the search space is associated with the first resource pool.

In one embodiment, the first resource pool is configured.

In one embodiment, the first resource pool is pre-configured.

In one embodiment, the first resource pool is predefined.

In one embodiment, the first resource pool is associated with a ServCellIndex.

In one embodiment, the first resource pool is associated with a ServCellIndex, the ServCellIndex being equal to 0.

In one embodiment, the first resource pool is associated with a cell being used to receive the second signaling.

In one embodiment, the first resource pool comprises a CORESET.

In one embodiment, the first resource pool comprises a CORESET pool.

In one embodiment, the first resource pool comprises a CORESET resource pool.

In one embodiment, the first resource pool comprises all SSBs in the first cell.

In one embodiment, if the first node is configured with a second cell, the first resource pool comprises at least one SSB of the first cell, and the first resource pool comprises at least one SSB of the second cell; the second cell is a mobility management cell for the first cell.

In one embodiment, an index of the first resource pool is an index of at least one CORESET; an index of the first resource set in the first resource pool is an index of a Search Space in the at least one CORESET.

In one embodiment, any resource set in the first resource pool is a TAG, and the first resource set is a TAG in the first resource pool.

In one embodiment, the first resource pool corresponds to the first cell and the first resource set corresponds to a TRP in a maintenance base station for the first cell.

In one embodiment, the first resource pool corresponds to multiple TAGs, and the first resource set corresponds to one TAG of the multiple TAGs; the multiple TAGs belong to a same cell group, the same cell group being a Master Cell Group (MCG); and each TAG of the multiple TAGs is associated with a PCell.

In one embodiment, the first resource pool corresponds to multiple TAGs, and the first resource set corresponds to one TAG of the multiple TAGs; the multiple TAGs belong to a same cell group, the same cell group being an SCG; and each TAG of the multiple TAGs is associated with a PSCell.

In one embodiment, the index of the first resource pool is used to determine that the multiple resource sets belong to the first resource pool.

In one embodiment, the index of the first resource pool is used to indicate a SpCell.

In one embodiment, the index of the first resource pool is used to indicate a PCell.

In one embodiment, the index of the first resource pool is used to indicate a PSCell.

In one embodiment, the index of the first resource pool is used to indicate a serving cell.

In one embodiment, the index of the first resource pool includes a cell identity.

In one embodiment, the index of the first resource pool is an index of a CORESET.

In one embodiment, the index of the first resource pool is an index of a CORESET pool.

In one embodiment, the index of the first resource pool is an index of a CORESET resource pool.

In one embodiment, the index of the first resource pool is a PCI of the first cell.

In one embodiment, the index of the first resource pool is a ServCellIndex of the first cell.

In one embodiment, the index of the first resource pool is a ServCellIndex.

In one embodiment, the index of the first resource pool is a ServCellIndex, the ServCellIndex being equal to 0.

In one embodiment, the index of the first resource pool is a non-negative integer.

In one embodiment, the index of the first resource pool is a positive integer.

In one embodiment, the index of the first resource pool is 0.

In one embodiment, the index of the first resource pool is configurable.

In one embodiment, the index of the first resource pool is pre-configured.

In one embodiment, each resource set in the first resource pool is predefined.

In one embodiment, each resource set in the first resource pool is pre-configured.

In one embodiment, each resource set in the first resource pool is configured via broadcast signaling.

In one embodiment, each resource set in the first resource pool is configured via dedicated signaling.

In one embodiment, each resource set in the first resource pool is configured via an RRC message.

In one embodiment, each resource set in the first resource pool is configured via a SIB message.

In one embodiment, each resource set in the first resource pool is configured via a RRCReconfiguration message.

In one embodiment, if one resource set is configured with the index of the first resource pool, the one resource set belongs to the first resource pool.

In one embodiment, the index of the first resource set in the first resource pool is used to indicate the first resource set in the first resource pool.

In one embodiment, the index of the first resource set in the first resource pool is an index of a search space.

In one embodiment, the index of the first resource set in the first resource pool is an index of a TRP.

In one embodiment, the index of the first resource set in the first resource pool is an index of a resource set.

In one embodiment, the index of the first resource set in the first resource pool is an index of an RS resource set.

In one embodiment, the index of the first resource set in the first resource pool is an index of a TAG.

In one embodiment, the index of the first resource set in the first resource pool is an index of a CORESET.

In one embodiment, the index of the first resource set in the first resource pool is an index of a CORESET subset.

In one embodiment, the index of the first resource set in the first resource pool is an index of a TCI set.

In one embodiment, the index of the first resource set in the first resource pool is an index of a TCI.

In one embodiment, the index of the first resource set in the first resource pool is a non-negative integer.

In one embodiment, the index of the first resource set in the first resource pool is a positive integer.

In one embodiment, the index of the first resource set in the first resource pool is either 0 or 1.

In one embodiment, the index of the first resource set in the first resource pool is one of 00 or 01 or 10 or 11.

In one embodiment, any resource set in the first resource pool is associated with an index.

In one embodiment, any resource set in the first resource pool corresponds to an index.

In one embodiment, any resource set in the first resource pool is configured with an index.

In one embodiment, any resource set in the first resource pool is indicated by an index.

In one embodiment, the first resource pool is a cell being used to receive the second signaling.

In one embodiment, the first resource pool comprises a Type1-PDCCH CSS set.

In one embodiment, the first resource set comprises a subset of the Type1-PDCCH CSS set.

In one embodiment, an index of the first resource set in the first resource pool includes an index of a search space.

In one embodiment, an index of the first resource set in the first resource pool includes an index of the first SSB.

In one embodiment, the first resource set is configured with an index of the first resource pool.

In one embodiment, the at least one spatial parameter of the first signaling is: antenna port quasi co-location properties of the first signaling.

In one embodiment, the first node is configured with Carrier Aggregation (CA).

In one embodiment, the first node is not configured with Carrier Aggregation (CA).

In one embodiment, the fourth signaling in this application is monitored.

In one embodiment, the fourth signaling in this application is not monitored.

In one embodiment, at least one spatial parameter of a signaling is at least one spatial parameter of a PDCCH being used to monitor the signaling.

In one embodiment, at least one spatial parameter of a signaling is at least one spatial parameter of a PDCCH being used to receive the signaling.

Typically, the at least one spatial parameter of a signaling is an antenna port quasi co-location property of the signaling.

Typically, the at least one spatial parameter of a signaling is an antenna port quasi co-location property being used to monitor the signaling.

Typically, the at least one spatial parameter of a signaling is an antenna port quasi co-location property being used to receive the signaling.

In one embodiment, the above signaling is the first signaling.

In one embodiment, the above signaling is the second signaling of the present application.

In one embodiment, the above signaling is the third signaling of the present application.

In one embodiment, the above signaling is the fourth signaling of the present application.

In one embodiment, a CORESET is used to determine a time/frequency control resource set for searching a DCI.

In one embodiment, a CORESET includes time-domain resources and frequency-domain resources.

In one embodiment, a search space includes a set of PDCCH candidates, the set of PDCCH candidates being used to monitor a PDCCH.

In one embodiment, a search space is used to monitor a PDCCH.

In one embodiment, a search space is used to search for PDCCH candidates.

In one embodiment, a search space is configured by an RRC message.

In one embodiment, a search space is configured by a SearchSpace IE.

In one embodiment, a search space is indexed by a SearchSpaceId.

In one embodiment, the CORESET is defined with reference to 3GPP TS 38.331.

In one embodiment, the search space is defined with reference to 3GPP TS 38.331.

### Embodiment 2

Embodiment 2 illustrates a schematic diagram of a network architecture according to one embodiment of the present application, as shown in FIG. 2. FIG. 2 illustrates a network architecture 200 of 5G New Radio (NR)/Long-Term Evolution (LTE)/Long-Term Evolution Advanced (LTE-A) systems. The 5G NR/LTE/LTE-A network architecture 200 may be called a 5G System/Evolved Packet System (5GS/EPS) 200 or other suitable terminology. The 5GS/EPS 200 may comprise UE(s) 201, a RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The RAN comprises a node 203 and another node 204. The node 203 provides UE 201 oriented user plane and control plane terminations. The node 203 can be connected to other node 204 via an Xn interface (like backhaul)/X2 interface. The node 203 may be called a base station, a base transceiver station, a radio base station, a radio transceiver, a transceiver function, a Base Service Set (BSS), an Extended Service Set (ESS), a Transmitter

Receiver Point (TRP) or some other applicable terms. The node 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 corresponds to the first node in the present application; and the node 203 corresponds to the second node in the present application.

In one embodiment, the UE 201 corresponds to the first node in the present application; and the node 203 corresponds to a portion of the second node in the present application.

In one embodiment, the UE 201 corresponds to the first node in the present application; and the node 204 corresponds to the second node in the present application.

In one embodiment, the UE 201 corresponds to the first node in the present application; and the node 204 corresponds to a portion of the second node in the present application.

In one embodiment, the UE 201 corresponds to the first node in the present application; the node 203 corresponds to the first sub-node in the present application; the node 204 corresponds to the second sub-node in the present application; the second node comprises the first sub-node and the second sub-node.

In one embodiment, the UE 201 is a UE.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a TRP.

In one embodiment, the node 203 is a NodeB (NB).

In one embodiment, the node 203 is a gNB.

In one embodiment, the node 203 is an eNB.

In one embodiment, the node 203 is a ng-eNB.

In one embodiment, the node 203 is an en-gNB.

In one embodiment, the node 203 is a UE.

In one embodiment, the node 203 is a relay.

In one embodiment, the node 203 is a Gateway.

In one embodiment, the node 204 is a BS.

In one embodiment, the node 204 is a BTS.

In one embodiment, the node 204 is a TRP.

In one embodiment, the node 204 is a NB.

In one embodiment, the node 204 is a gNB.

In one embodiment, the node 204 is an eNB.

In one embodiment, the node 204 is a ng-eNB.

In one embodiment, the node 204 is an en-gNB.

In one embodiment, the node 204 is a UE.

In one embodiment, the node 204 is a relay.

In one embodiment, the node 204 is a Gateway.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE comprises an aircraft.

In one embodiment, the UE comprises a vehicle-mounted terminal.

In one embodiment, the UE comprises a vessel.

In one embodiment, the UE comprises an Internet-of-Things (IoT) terminal.

In one embodiment, the UE comprises an Industrial IoT (IIoT) terminal.

In one embodiment, the UE comprises a piece of equipment supporting transmissions with low delay and high reliability.

In one embodiment, the UE comprises test equipment.

In one embodiment, the UE comprises a signaling test instrument.

In one embodiment, the base station supports transmissions in NTN.

In one embodiment, the base station supports transmissions in large-delay-difference networks.

In one embodiment, the base station supports transmissions in TN.

In one embodiment, the base station comprises a MacroCellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station device supporting large time-delay difference.

In one embodiment, the base station comprises a flight platform.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling test instrument.

In one embodiment, the base station comprises an Integrated Access and Backhaul-node (IAB-node).

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises a L3 relay.

In one embodiment, the relay comprises a L2 relay.

In one embodiment, the relay comprises a Router.

In one embodiment, the relay comprises an Exchanger.

In one embodiment, the relay comprises a UE.

In one embodiment, the relay comprises a base station.

### Embodiment 3

Embodiment 3 illustrates a schematic diagram of a radio protocol architecture of a user plane and a

control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are layer1, layer2 and layer3.The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the first signal in the present application is generated by the RRC 306.

In one embodiment, the first signal in the present application is generated by the MAC 302 or the MAC 352.

In one embodiment, the first signal in the present application is generated by the PHY 301 or the PHY 351.

In one embodiment, the first signaling in the present application is generated by the PHY 301 or the PHY 351.

In one embodiment, the second signaling in the present application is generated by the PHY 301 or the PHY 351.

In one embodiment, the third signaling in the present application is generated by the MAC 302 or the MAC 352.

In one embodiment, the third signaling in the present application is generated by the PHY 301 or the PHY 351.

In one embodiment, the fourth signaling in the present application is generated by the PHY 301 or the PHY 351.

In one embodiment, the second signal in the present application is generated by the PHY 301 or the PHY 351.

### Embodiment 4

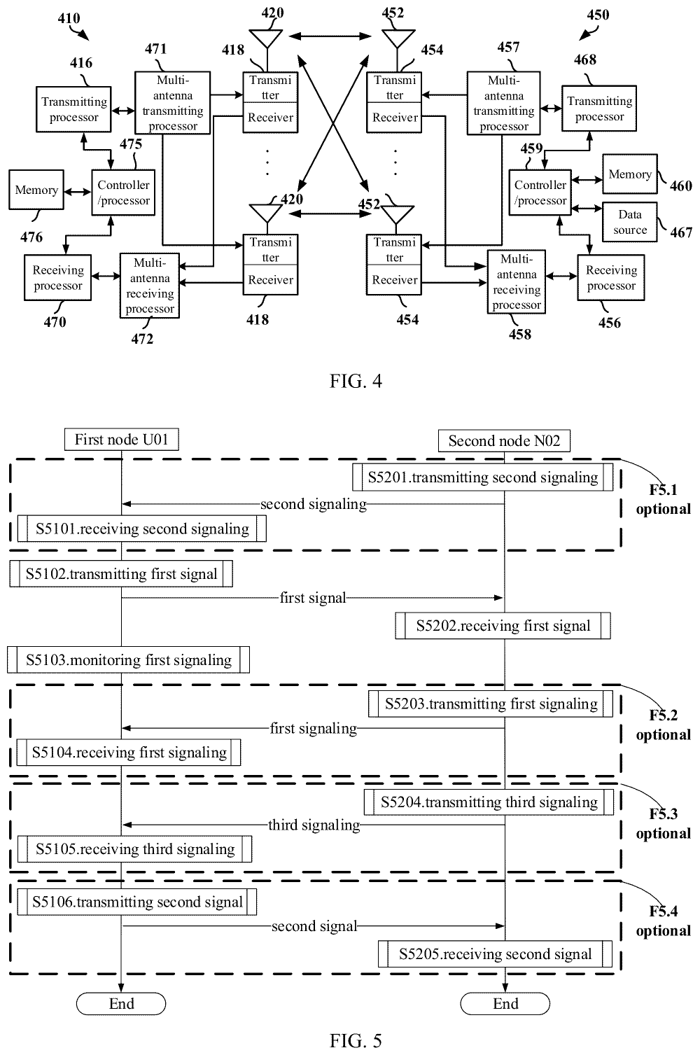

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e.., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e.., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450—targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least transmits a first signal, the first signal including at least a random access preamble; and monitors a first signaling in a first time window, the first signaling being used to schedule a random access response for the first signal, an end time in time domain of the first signal being used to determine a start of the first time window; herein, the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.

In one embodiment, the first communication device 450 comprises a memory that stores a computer readable instruction program. The computer readable instruction program generates actions when executed by at least one processor. The actions include: transmitting a first signal, the first signal including at least a random access preamble; and monitoring a first signaling in a first time window, the first signaling being used to schedule a random access response for the first signal, an end time in time domain of the first signal being used to determine a start of the first time window; herein, the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.

In one embodiment, the second communication device 410 comprises at least one processor and at least one memory. The at least one memory comprises computer program codes; the at least one memory and the computer program codes are configured to be used in collaboration with the at least one processor. The second communication device 410 at least receives a first signal, the first signal including at least a random access preamble; and transmits a first signaling, the first signaling being used to schedule a random access response for the first signal; herein, the first signaling is monitored in a first time window, and an end time in time domain of the first signal is used to determine a start of the first time window; the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.

In one embodiment, the second communication device 410 comprises a memory that stores a computer readable instruction program. The computer readable instruction program generates actions when executed by at least one processor. The actions include: receiving a first signal, the first signal including at least a random access preamble; and transmitting a first signaling, the first signaling being used to schedule a random access response for the first signal; herein, the first signaling is monitored in a first time window, and an end time in time domain of the first signal is used to determine a start of the first time window; the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.

In one embodiment, the antenna 452, the receiver 454, the receiving processor 456 and the controller/processor 459 are used for monitoring and/or receiving a first signaling; at least one of the antenna 420, the transmitter 418, the transmitting processor 416 or the controller/processor 475 is used for transmitting a first signaling.

In one embodiment, the antenna 452, the receiver 454, the receiving processor 456 and the controller/processor 459 are used for monitoring and/or receiving a second signaling; at least one of the antenna 420, the transmitter 418, the transmitting processor 416 or the controller/processor 475 is used for transmitting a second signaling.

In one embodiment, the antenna 452, the receiver 454, the receiving processor 456 and the controller/processor 459 are used for monitoring and/or receiving a third signaling; at least one of the antenna 420, the transmitter 418, the transmitting processor 416 or the controller/processor 475 is used for transmitting a third signaling.

In one embodiment, the antenna 452, the transmitter 454, the transmitting processor 468 and the controller/processor 459 are used for transmitting a first signal; at least one of the antenna 420, the receiver 418, the receiving processor 470 or the controller/processor 475 is used for receiving a first signal.

In one embodiment, the antenna 452, the transmitter 454, the transmitting processor 468 and the controller/processor 459 are used for transmitting a second signal; at least one of the antenna 420, the receiver 418, the receiving processor 470 or the controller/processor 475 is used for receiving a second signal.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a UE supporting large delay difference.

In one embodiment, the first communication device 450 is a UE supporting NTN.

In one embodiment, the first communication device 450 is an aircraft.

In one embodiment, the first communication device 450 is capable of positioning.

In one embodiment, the first communication device 450 is incapable of positioning.

In one embodiment, the first communication device 450 is a UE supporting TN.

In one embodiment, the second communication device 410 is a base station (gNB/eNB/ng-eNB).

In one embodiment, the second communication device 410 is a base station supporting large delay difference.

In one embodiment, the second communication device 410 is a base station supporting NTN.

In one embodiment, the second communication device 410 is satellite equipment.

In one embodiment, the second communication device 410 is a flight platform.

In one embodiment, the second communication device 410 is a base station supporting TN.

### Embodiment 5

Embodiment 5 illustrates a flowchart of radio signal transmission according to one embodiment of the present application, as shown in FIG. 5. It should be particularly noted that the sequence illustrated herein does not set any limit to the signal transmission order or implementation order in the present application.

The first node U01 receives a second signaling in step S5101, the second signaling being used to trigger the first signal; and transmits a first signal in step S5102, the first signal including at least a random access preamble; and monitors a first signaling in a first time window in step S5103, the first signaling being used to schedule a random access response for the first signal, an end time in time domain of the first signal being used to determine a start of the first time window; and receives the first signaling in step S5104; receives a third signaling in step S5105, the third signaling indicating a first amount of timing advance; and transmits a second signal in step S5106.

The second node N02 transmits the second signaling in step S5201; receives the first signal in step S5202; transmits the first signaling in step S5203; transmits the third signaling in step S5204; and receives the second signal in step S5205.

In Embodiment 5, the second signaling is used to determine that the first signal is associated with the first resource set; the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool; the first signaling is used to determine physical layer scheduling information for a first channel, the first channel being used to carry at least the third signaling; the first amount of timing advance is used to determine a transmission time for the second signal; the second signal being associated with the first resource set.

In one embodiment, the first node U01 is a UE.

In one embodiment, the first node U01 is a relay device.

In one embodiment, the first node U01 is an end device.

In one embodiment, the second node N02 is a base station.

In one embodiment, the second node N02 is a relay device.

In one embodiment, the second node N02 comprises at least a TRP.

In one embodiment, the second node N02 comprises at least two TRPs.

In one embodiment, the second node N02 is a virtual node.

In one embodiment, the second node N02 is a physical node.

In one embodiment, the second node N02 comprises the first sub-node N021 of this application and the second sub-node N022 of this application.

In one embodiment, the second signaling indicating at least one of an index of the first resource set in the first resource pool or an index of the first resource pool is used to determine that the first signal is associated with the first resource set.

In one embodiment, at least one spatial parameter of the first signaling is associated with a Type1-PDCCH CSS set if the second signaling indicates at least one of an index of the first resource set in the first resource pool or an index of the first resource pool.

In one embodiment, if the second signaling indicates an index of the first resource pool, at least one spatial parameter of the first signaling is associated with a Type1-PDCCH CSS set.

In one embodiment, if the second signaling indicates an index of the first resource set in the first resource pool, at least one spatial parameter of the first signaling is associated with a Type1-PDCCH CSS set.

Typically, a Random Access Preamble index field in the second signaling is not set to all zeros; the first random access procedure is a CFRA of a PDCCH order.

In one embodiment, the second signaling is used for a random access procedure initiated by a PDCCH order.

In one embodiment, the second signaling is a DCI.

In one embodiment, the second signaling is in a format of DCI format 1_0.

In one embodiment, the second signaling is in a format of DCI format 1_1.

In one embodiment, the second signaling is in a format of DCI format 1_2.

In one embodiment, the second signaling is used to schedule a PDSCH.

In one embodiment, the second signaling is downlink control information.

In one embodiment, the second signaling is a PDCCH order.

In one embodiment, the second signaling includes an Identifier for DCI formats field, the Identifier for DCI formats field being set to 1.

In one embodiment, the second signaling includes a Frequency domain resource assignment field, the Frequency domain resource assignment field being set to all ones.

In one embodiment, the second signaling includes a DCI format 1_0; the second signaling includes an Identifier for DCI formats field, the Identifier for DCI formats field being set to 1; the second signaling includes a Frequency domain resource assignment field, the Frequency domain resource assignment field being set to all ones.

In one embodiment, the second signaling includes a DCI format 1_0; the second signaling includes an

Identifier for DCI formats field, the Identifier for DCI formats field being set to 1; the second signaling includes a Frequency domain resource assignment field, the Frequency domain resource assignment field being set to all ones; and the second signaling includes a Random Access Preamble index field, the Random Access Preamble index field not being set to all zeros.

In one embodiment, the second signaling includes a DCI format 1_0; the second signaling includes an Identifier for DCI formats field, the Identifier for DCI formats field being set to 1; the second signaling includes a Frequency domain resource assignment field, the Frequency domain resource assignment field being set to all ones; and the second signaling includes a Random Access Preamble index field, the Random Access Preamble index field being set to all zeros.

In one embodiment, a Cyclic Redundancy Check (CRC) of the second signaling is scrambled by a Cell Radio Network Temporary Identifier (C-RNTI).

In one embodiment, the CRC of the second signaling is scrambled by a Configured Scheduling RNTI (CS-RNTI).

In one embodiment, the CRC of the second signaling is scrambled by an MCS-RNTI.

In one embodiment, the CRC of the second signaling is scrambled by one of a C-RNTI or a CS-RNTI or an MCS-RNTI.

In one embodiment, the second signaling indicates at least one of an index of the first resource set in the first resource pool or an index of the first resource pool.

In one embodiment, the second signaling explicitly indicates the index of the first resource pool.

In one embodiment, the second signaling implicitly indicates the index of the first resource pool.

In one embodiment, the index of the first resource pool is an index of a cell used to receive the second signaling.

In one embodiment, the index of the first resource pool is an index of at least one CORESET to which the second signaling belongs.

In one embodiment, the second signaling explicitly indicates the index of the first resource set in the first resource pool.

In one embodiment, the second signaling implicitly indicates the index of the first resource set in the first resource pool.

In one embodiment, the second signaling is used to trigger a random access procedure, the first signal belonging to the random access procedure.

In one embodiment, the second signaling is used to trigger a random access procedure, the first signal being transmitted during the random access procedure.

In one embodiment, the second signaling is used to indicate at least the first three of an index of a random access preamble included in the first signal, an index of an SS/PBCH associated with the random access preamble included in the first signal, or an index of a PRACH mask associated with a random access preamble included in the first signal, or an uplink carrier associated with the random access preamble included in the first signal.

In one embodiment, the second signaling is used to determine that the first SSB is associated with the first resource set.

In one embodiment, the second signaling indicates that the first SSB is associated with the first resource set.

In one embodiment, that the second signaling includes an index of the first SSB and the second signaling includes an index of the first resource set is used to determine that the first SSB is associated with the first resource set.

In one embodiment, that the second signaling includes an index of the first SSB and the first SSB belongs to the first resource set is used to determine that the first SSB is associated with the first resource set.

In one embodiment, if the second signaling indicates an index of the first resource set in the first resource pool, at least one spatial parameter of the first signaling is related to at least one of an index of the first resource set in the first resource pool or an index of the first resource pool.

In one embodiment, if the second signaling indicates an index of the first resource set in the first resource pool, and the Random Access Preamble index field in the second signaling is not set to all zeros, at least one spatial parameter of the first signaling is related to at least one of an index of the first resource set in the first resource pool or an index of the first resource pool.

In one embodiment, if the second signaling indicates an index of the first resource set in the first resource pool, at least one spatial parameter of the first signaling is the same as at least one spatial parameter of the first SSB.

In one embodiment, if the second signaling indicates an index of the first resource pool, at least one spatial parameter of the first signaling is the same as at least one spatial parameter of the first SSB.

In one embodiment, if the second signaling indicates an index of the first resource set in the first resource pool, at least one spatial parameter of the first signaling is the same as at least one spatial parameter of the second signaling.

In one embodiment, if the second signaling indicates an index of the first resource pool, at least one spatial parameter of the first signaling is the same as at least one spatial parameter of the second signaling.

In one embodiment, the CRC of the first signaling is scrambled by a RA-RNTI, the RA-RNTI corresponding to a random access preamble in the first signal, the first signaling is in the format of DCI format 1_0, and the second signaling is used to trigger the first signal.

In one embodiment, the CRC of the first signaling is scrambled by a C-RNTI, the first signaling is a DCI, and the second signaling is used to trigger the first signal.

In one embodiment, the CRC of the first signaling is scrambled by a MSGB-RNTI, the first signaling is a DCI, and the second signaling is used to trigger the first signal.

In one embodiment, the second signaling includes a Random Access Preamble index field, the Random Access Preamble index field being set to all zeros.

In one embodiment, the first SSB is selected among SSBs associated with the first resource set.

In one subembodiment, if SS_RSRP of at least one SSB associated with the first resource set is higher than an RSRP threshold, an SSB of which the SS_RSRP is higher than the RSRP threshold is selected among the at least one SSB associated with the first resource set, the SSB being selected being the first SSB; the RSRP threshold is configurable.

In one subembodiment, if SS_RSRP of any SSB associated with the first resource set is not higher than an RSRP threshold, any one SSB is selected among all SSBs associated with the first resource set, the any one SSB being selected being the first SSB; the RSRP threshold is configurable.

In one embodiment, an index of at least one CORESET to which the second signaling belongs is an index of the first resource set.

In one embodiment, an index of a search space to which the second signaling belongs is an index of the first resource set in the first resource pool.

In one embodiment, the second signaling includes an index of the first resource set.

In one embodiment, a target DCI field in the second signaling is used to indicate the first resource set.

In one embodiment, a DCI format to which the second signaling belongs includes a target DCI field, the target DCI field being set to a state being used to indicate a resource set in the first resource pool.

In one subembodiment, the target DCI field is a DCI field in the DCI format 1_0 other than a Random Access Preamble index field, a UL/SUL indicator field, an SS/PBCH index field, a PRACH Mask index field, and Reserved bits.

In one subembodiment, the target DCI field is a UL/SUL indicator field in the DCI format 1_0.

In one subembodiment, the target DCI field is at least 1 bit after the Random Access Preamble index field in the DCI format 1_0.

In one subembodiment, the target DCI field is at least 1 bit after the PRACH Mask index field in the DCI format 1_0.

In one subembodiment, any of the states that the target DCI field can be set to is a non-negative integer.

In one subembodiment, the target DCI field being set to all ones is used to indicate a resource set, and the target DCI field being set to all zeros is used to indicate another resource set; the first resource pool including 2 resource sets.

In one subembodiment, that the target DCI field is set to 00, 01, 10 and 11 is used to indicate a resource set, respectively.

In one embodiment, the second signaling includes a Random Access Preamble index field, the Random Access Preamble index field not being set to all zeros; the Random Access Preamble index field indicates an index of the random access preamble included in the first signal.

In one subembodiment, the second signaling includes a UL/SUL indicator field; the UL/SUL indicator field indicates an uplink carrier transmitting a PRACH.

In one subembodiment, the second signaling does not include a UL/SUL indicator field.

In one subembodiment, the second signaling includes an SS/PBCH index field, the SS/PBCH index field indicating an index of the first SSB.

In one subembodiment, the second signaling includes a PRACH Mask index field; the PRACH Mask index field indicates an index of a PRACH mask for a random access preamble in the first signal; the PRACH Mask index field is used to determine a PRACH occasion for a random access preamble in the first signal, the PRACH occasion being related to the first SSB.

In one embodiment, the phrase that the second signaling is used to determine that the first signal is associated with the first resource set includes that the second signaling is used to determine that the first signal is determined according to the first resource set.

In one embodiment, the phrase that the second signaling is used to determine that the first signal is associated with the first resource set includes that the second signaling is used to determine the first resource set, the first signal being related to the first resource set.

In one embodiment, the phrase that the second signaling is used to determine that the first signal is associated with the first resource set includes that the second signaling explicitly indicates that the first signal is associated with the first resource set.

In one embodiment, the phrase that the second signaling is used to determine that the first signal is associated with the first resource set includes that the second signaling implicitly indicates that the first signal is associated with the first resource set.

In one embodiment, the phrase that the second signaling is used to determine that the first signal is associated with the first resource set includes that a DCI field in the second signaling is used to determine that the first signal is associated with the first resource set.

In one embodiment, the phrase that the second signaling is used to determine that the first signal is associated with the first resource set includes that at least one spatial parameter of the second signaling is used to determine that the first signal is associated with the first resource set.

In one embodiment, at least one spatial parameter of the first signaling is related to at least one of an index of the first resource set in the first resource pool or an index of the first resource pool.

In one embodiment, the first signaling indicates a first amount of timing advance.

In one embodiment, the phrase of the first signaling being used to schedule a random access response for the first signal comprises: the first signaling being a random access response for the first signal; the first signaling indicating a first amount of timing advance.

In one subembodiment, the first signaling includes a Timing Advance Command field, the Timing Advance Command field indicating the first amount of timing advance.

In one subembodiment, a DCI field in the first signaling is used to determine the first amount of timing advance.

In one subembodiment, the above DCI field in the first signaling comprises a positive integer number of bit(s).

In one subembodiment, the above DCI field in the first signaling comprises 12 bits.

In one subembodiment, the above DCI field in the first signaling comprises 6 bits.

In one embodiment, the first signaling is used to schedule the third signaling.

In one embodiment, the third signaling in this application comprises the random access response for the first signal in this application.

In one embodiment, the random access response for the first signaling in this application is the third signaling in this application.

In one embodiment, the random access response for the first signal in this application and the third signaling in this application are mutually replaceable.

In one embodiment, the phrase that the third signaling includes the random access response for the first signal comprises: the third signaling including at least the random access response for the first signal.

In one embodiment, the phrase that the third signaling includes the random access response for the first signal comprises: the third signaling being the random access response for the first signal.

In one embodiment, the phrase that the third signaling includes the random access response for the first signal comprises: the third signaling including a MAC RAR, the MAC RAR being the random access response for the first signal.

In one embodiment, the third signaling includes a MAC subPDU, the MAC subPDU including a MAC RAR and a MAC subheader, the MAC subheader indicating Random Access Preamble identifiers (RAPID), the Random Access Preamble identifiers matching with an index of the random access preamble in the first signal.

In one embodiment, the random access response for the first signal includes a field, the field being used to indicate an index value of a total amount of timing adjustment.

In one embodiment, at least one spatial parameter of the third signaling is indicated by the first signaling.

In one embodiment, the antenna port quasi co-location properties of the third signaling are indicated by the first signaling.

In one embodiment, a TCI of the third signaling is indicated by the first signaling.

In one embodiment, the third signaling is scrambled by a C-RNTI or a CS-RNTI or an MCS-RNTI.

In one embodiment, the third signaling is scrambled by a MSGB-RNTI.

In one embodiment, the third signaling is scrambled by a RA-RNTI.

In one embodiment, the third signaling is scrambled by a C-RNTI.

In one embodiment, the third signaling comprises a field in a Timing Advance Command MAC CE.

In one embodiment, the third signaling comprises a Timing Advance Command MAC CE.

In one embodiment, the third signaling comprises an Absolute Timing Advance Command MAC CE.

In one embodiment, the third signaling includes a Timing Advance Command field, the Timing Advance Command field indicating the first amount of timing advance.

In one embodiment, a MAC field in the third signaling is used to determine the first amount of timing advance.

In one embodiment, the above MAC field in the third signaling comprises a positive integer number of bit(s).

In one embodiment, the above MAC field in the third signaling comprises 12 bits.

In one embodiment, the above MAC field in the third signaling comprises 6 bits.

In one embodiment, the above MAC field in the third signaling indicates one index value, the one index value being used to determine the first amount of timing advance.

In one embodiment, the first amount of timing advance is not applied to adjustment of an uplink transmission timing associated with one resource set other than the first resource set in the first resource pool.

In one embodiment, the first amount of timing advance is applied to adjustment of an uplink transmission timing associated with the first resource set.

In one embodiment, the first amount of timing advance is N_{TA}.

In one embodiment, the first amount of timing advance is T_{c}.

In one embodiment, the first amount of timing advance comprises at least one T_{c}.

In one embodiment, the first amount of timing advance comprises at least one 16·64·T_{c}/2^{μ}.

In one embodiment, the first amount of timing advance is equal to the product of the one index value and one granularity.

In one embodiment, the one granularity is related to Subcarrier spacing (SCS).

In one embodiment, the one granularity is predefined.

In one embodiment, the one granularity is measured in milliseconds.

In one embodiment, the one granularity comprises at least one T_{c}.

In one embodiment, the one granularity is 16·64·T_{c}/24^{μ}; where the SCS is 2^{μ}·15 kHz; the μ and the T_{c} are defined with reference to TS 38.213.

In one embodiment, the one granularity is 16·64/2^{μ}; where the SCS is 2^{μ}·15 kHz; the μ is defined with reference to TS 38.213.

In one embodiment, the one index value is T_{A}.

In one embodiment, the one index value is a non-negative integer.

In one embodiment, the one index value is a positive integer.

In one embodiment, the one index value is not less than 0 and the one index value is not greater than 3846.

In one embodiment, the one index value is not less than 0 and the one index value is not greater than

In one embodiment, the second signal is transmitted on a PUSCH.

In one embodiment, the second signal is transmitted on a PUCCH.

In one embodiment, the second signal comprises a Sounding Reference Signal (SRS).

In one embodiment, the second signal comprises a UCI (i.e., Uplink control information).

In one embodiment, the second signal is a UCI.

In one embodiment, the second signal is an SRS signal.

In one embodiment, the second signal is an uplink signal.

In one embodiment, the second signal is a physical layer signal.

In one embodiment, the second signal is a PUSCH or an SRS or a PUCCH.

In one embodiment, the phrase that the first amount of timing advance is used to determine a transmission time for the second signal comprises: determining the transmission time for the second signal based on the first amount of timing advance.

In one embodiment, the phrase that the first amount of timing advance is used to determine a transmission time for the second signal comprises: the first amount of timing advance being used to adjust an uplink transmission timing of the second signal.

In one embodiment, a receiver of the second signal is associated with the first resource set.

In one embodiment, a receiver of the second signal belongs to the first resource set.

In one embodiment, a spatial parameter of the second signal is associated with the first resource set.

In one embodiment, the dashed-line box F5.2 is optional.

In one subembodiment, the dashed-line box F5.2 exists.

In one subembodiment, the dashed-line box F5.2 does not exist.

In one embodiment, the dashed-line box F5.2 is not optional, and the dashed-line box F5.2 is present.

In one embodiment, the dashed-line box F5.2 is optional.

In one subembodiment, the dashed-line box F5.2 exists.

In one subsidiary embodiment of the above subembodiment, the first signaling is transmitted, and the first signaling is received.

In one subembodiment, at least part of the dashed-line box F5.2 does not exist.

In one subsidiary embodiment of the above subembodiment, the first signaling is transmitted, and the first signaling is not received.

In one subsidiary embodiment of the above subembodiment, the first signaling is not transmitted, and the first signaling is not received.

In one embodiment, the dashed-line box F5.3 is optional.

In one subembodiment, the dashed-line box F5.3 exists.

In one subsidiary embodiment of the above subembodiment, the third signaling is transmitted, and the third signaling is received.

In one subsidiary embodiment of the above subembodiment, the first signaling is used to schedule the third signaling.

In one subembodiment, at least part of the dashed-line box F5.3 does not exist.

In one subsidiary embodiment of the above subembodiment, the third signaling is transmitted, and the third signaling is not received.

In one subsidiary embodiment of the above subembodiment, the third signaling is not transmitted, and the third signaling is not received.

In one subsidiary embodiment of the above subembodiment, the first signaling is not used to schedule the third signaling.

In one embodiment, the dashed-line box F5.4 is optional.

In one subembodiment, the dashed-line box F5.4 exists.

In one subsidiary embodiment of the above subembodiment, the second signal is transmitted, and the second signal is received.

In one subembodiment, at least part of the dashed-line box F5.4 does not exist.

In one subsidiary embodiment of the above subembodiment, the second signal is transmitted, and the second signal is not received.

In one subsidiary embodiment of the above subembodiment, the second signal is not transmitted, and the second signal is not received.

In one embodiment, the dashed-line box F5.2 exists and at least part of the dashed-line box F5.3 exists.

In one embodiment, the dashed-line box F5.2 exists and the dashed-line box F5.3 does not exist.

In one embodiment, the dashed-line box F5.2 exists and at least part of the dashed-line box F5.4 exists.

In one embodiment, the dashed-line box F5.2 exists and the dashed-line box F5.4 does not exist.

In one embodiment, the dashed-line box F5.2 does not exist and the dashed-line box F5.3 does not exist.

In one embodiment, the dashed-line box F5.2 does not exist and the dashed-line box F5.4 does not exist.

In one embodiment, the dashed-line box F5.3 exists and the dashed-line box F5.4 exists.

In one embodiment, the dashed-line box F5.3 exists and the dashed-line box F5.4 does not exist.

### Embodiment 6

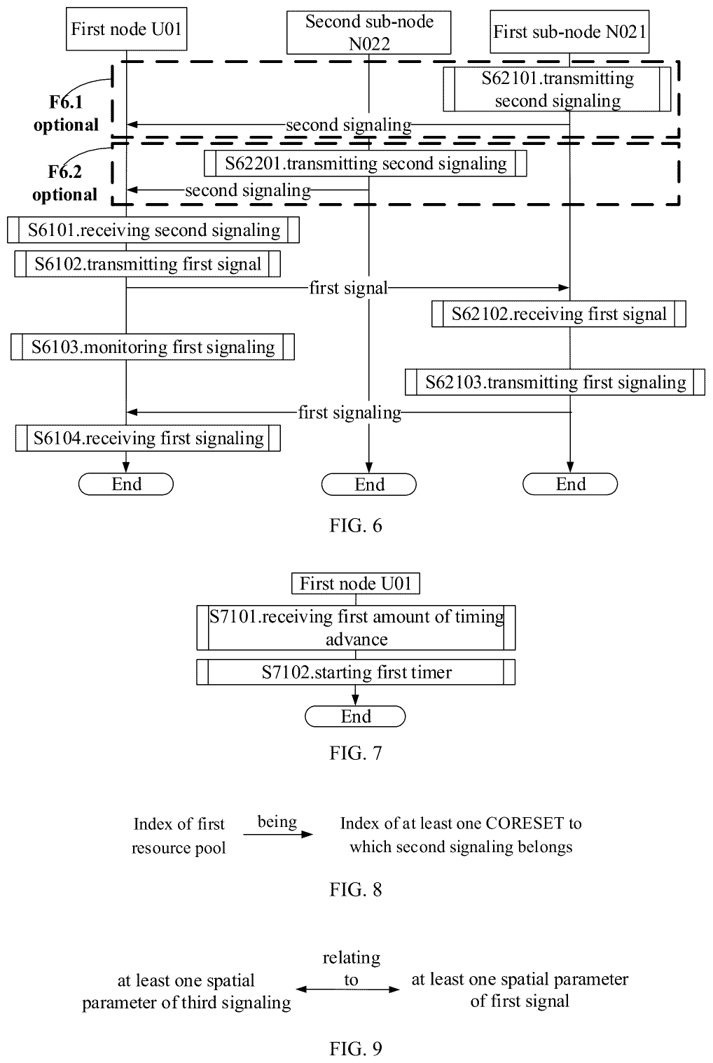

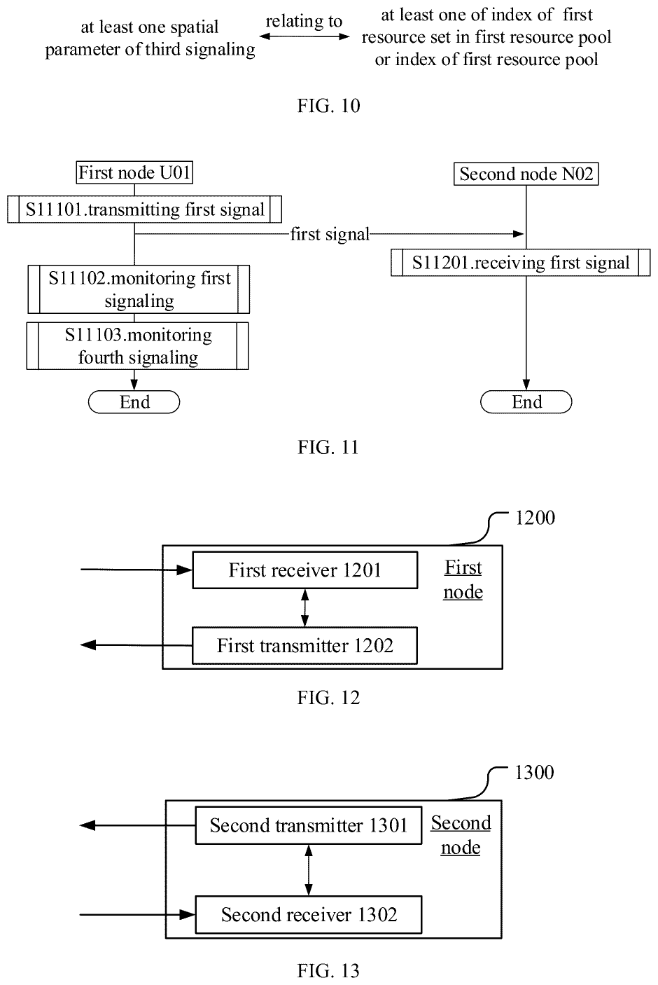

Embodiment 6 illustrates a flowchart of signal transmission according to another embodiment of the present application, as shown in FIG. 6. It should be particularly noted that the sequence illustrated herein does not set any limit to the signal transmission order or implementation order in the present application.

The first node U01 receives a second signaling in step S6101, the second signaling being used to trigger the first signal; and transmits a first signal in step S6102, the first signal including at least a random access preamble; and monitors a first signaling in a first time window in S6103, the first signaling being used to schedule a random access response for the first signal, an end time in time domain of the first signal being used to determine a start of the first time window; and receives the first signaling in step S6104.

The first sub-node N021 transmits the second signaling in step S62101; receives the first signal in step S62102; and transmits the first signaling in step S62103.

The second sub-node N022 transmits the second signaling in step S62201.

In Embodiment 6, the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool; the second signaling is used to determine that the first signal is associated with the first resource set.

In one embodiment, the first sub-node N021 is a part of the second node N02 in the present application. In one embodiment, the second sub-node N022 is a part of the second node N02 in the present

application.

In one embodiment, the first sub-node N021 is a TRP.

In one embodiment, the second sub-node N022 is a TRP.

In one embodiment, the first sub-node N021 belongs to a first cell, while the second sub-node N022 belongs to a second cell.

In one embodiment, the first sub-node N021 and the second sub-node N022 belong to two different Distributed Units (DUs).

In one subembodiment, the DU to which the first sub-node N021 belongs and the DU to which the second sub-node N022 belongs belong to a same Centralized Unit (CU).

In one subembodiment, the DU to which the first sub-node N021 belongs and the DU to which the second sub-node N022 belongs belong to two different CUs.

In one embodiment, the first sub-node N021 and the second sub-node N022 belong to a same DU.

In one embodiment, an uplink transmission timing associated with the first sub-node N021 and an uplink transmission timing associated with the second sub-node N022 are different.

In one embodiment, the first resource pool comprises the first resource set and the second resource set, the first resource set corresponding to the first sub-node N021 and the second resource set corresponding to the second sub-node N022.

In one embodiment, at least one spatial parameter of the first signaling is associated with the first SSB.

In one embodiment, at least one spatial parameter of the first signaling is associated with the first resource set.

In one embodiment, the second signaling includes a DCI format 1_0; the second signaling includes a Identifier for DCI formats field, the Identifier for DCI formats field being set to 1; the second signaling includes a Frequency domain resource assignment field, the Frequency domain resource assignment field being set to all ones; and the second signaling includes a Random Access Preamble index field, the Random Access Preamble index field not being set to all zeros.

In one embodiment, the dashed-line box F6.1 is optional.

In one subembodiment, the dashed-line box F6.1 exists.

In one subembodiment, the dashed-line box F6.1 does not exist.

In one embodiment, the dashed-line box F6.2 is optional.

In one subembodiment, the dashed-line box F6.2 exists.

In one subembodiment, the dashed-line box F6.2 does not exist.

In one embodiment, only one of the dashed-line box F6.1 or the dashed-line box F6.2 exists.

In one embodiment, both of the dashed-line box F6.1 and the dashed-line box F6.2 exist.

Embodiment 7

Embodiment 7 illustrates a flowchart of signal transmission according to a third embodiment of the present application, as shown in FIG. 7.

The first node U01 receives a first amount of timing advance in step S7101; and in step S7102, starts or restarts the first timer as a response to the first amount of timing advance being received.

In Embodiment 7, the first resource set is associated with the first timer.

In one embodiment, only the first resource set in the first resource pool is associated with the first timer.

In one embodiment, the state of the first timer is used to determine whether an uplink transmission associated with the first resource set is synchronized.

In one embodiment, if the first timer is running, the first node U01 considers an uplink transmission associated with the first resource set to be synchronized.

In one embodiment, if the first timer is not running, the first node U01 considers an uplink transmission associated with the first resource set to be non-synchronized.

In one embodiment, if the first timer expires, the first node U01 considers an uplink transmission associated with the first resource set to be non-synchronized.

In one embodiment, any resource set in the first resource pool is associated with a timer, and the state of the timer associated with the any resource set is used to determine whether an uplink transmission associated with the any resource set is synchronized.

In one embodiment, the uplink transmission being non-synchronized means that the uplink transmission is out of sync.

In one embodiment, the third signaling in the present application indicates a first amount of timing advance; the third signaling includes the random access response for the first signal.

In one embodiment, the third signaling in this application being received is used to determine receipt of the first amount of timing advance.

In one embodiment, the first amount of timing advance is received via the third signaling in this application.

In one embodiment, the first signaling in this application being received is used to determine that the first amount of timing advance is received.

In one embodiment, the first amount of timing advance is received via the first signaling in this application.

In one embodiment, the first signaling indicates the first amount of timing advance.

In one embodiment, the first signaling includes the first amount of timing advance.

In one embodiment, a field in the first signaling indicates the first amount of timing advance.

In one embodiment, starting or restarting a first timer as a response to the first amount of timing advance being received.

In one embodiment, as a response to the first amount of timing advance being received, starting a first timer if the first timer is not running.

In one embodiment, as a response to the first amount of timing advance being received, starting or restarting the first timer if the first random access procedure is a CFRA.

In one embodiment, starting or restarting a first timer as a response to the first amount of timing advance being received.

In one embodiment, starting a first timer as a response to the first amount of timing advance being received.

In one embodiment, the first signal is the random access preamble; the first signaling includes the first amount of timing advance.

In one embodiment, the first signal is a MSGA; the first signaling includes the first amount of timing advance.

In one embodiment, the first signal is the random access preamble; the third signaling includes an Absolute Timing Advance Command MAC CE, and the Absolute Timing Advance Command MAC CE includes the first amount of timing advance.

In one embodiment, the first signal is the random access preamble; the third signaling includes a MAC RAR, the MAC RAR including the first amount of timing advance.

In one embodiment, the first signal is an MSGA; the third signaling comprises a fallbackRAR, the fallbackRAR comprising the first amount of timing advance.

In one embodiment, the first signal is an MSGA; the third signaling comprises a successRAR, the successRAR comprising the first amount of timing advance.

In one embodiment, the first signal is an MSGA; the third signaling includes an Absolute Timing Advance Command MAC CE, and the Absolute Timing Advance Command MAC CE includes the first amount of timing advance.

In one embodiment, the first signaling and the third signaling are not simultaneously used to indicate the first amount of timing advance.

### Embodiment 8

Embodiment 8 illustrates a schematic diagram of an index of a first resource pool being an index of at least one CORESET to which a second signaling belongs according to one embodiment of the present application.

In Embodiment 8, the index of the first resource pool is an index of at least one CORESET to which the second signaling belongs.

In one embodiment, the at least one CORESET includes: one CORESET.

In one embodiment, the at least one CORESET includes: one or more CORESETs.

In one embodiment, the at least one CORESET includes: one CORESET pool.

In one embodiment, the at least one CORESET includes: one CORESET resource pool.

In one embodiment, at least one CORESET to which the second signaling belongs is at least one CORESET to which a PDCCH used to receive the second signaling belongs.

In one embodiment, at least one CORESET to which the second signaling belongs is associated with a SpCell.

In one embodiment, at least one CORESET to which the second signaling belongs is associated with the first cell

In one embodiment, at least one CORESET to which the second signaling belongs is associated with the second cell.

In one embodiment, at least one CORESET to which the second signaling belongs is associated with at least one of the first cell or the second cell.

In one embodiment, at least one CORESET to which the second signaling belongs is associated with a UE-specific search space (USS).

In one embodiment, at least one CORESET to which the second signaling belongs is associated with a CSS.

In one embodiment, at least one CORESET to which the second signaling belongs is not associated with any CSS.

In one embodiment, at least one CORESET to which the second signaling belongs is indexed by a controlResourceSetId.

In one embodiment, at least one CORESET to which the second signaling belongs is indexed by a coresetPoolIndex.

In one embodiment, the first resource pool includes at least one CORESET to which the second signaling belongs.

In one embodiment, at least one CORESET to which the second signaling belongs includes CORESET #0.

In one embodiment, at least one CORESET to which the second signaling belongs includes CORESET #1.

In one embodiment, an index of the first resource pool is an index of at least one CORESET to which the second signaling belongs; an index of the first resource set in the first resource pool is an index of a search space in the at least one CORESET.

In one embodiment, an index of the first resource pool is an index of at least one CORESET to which the second signaling belongs; an index of the first resource set in the first resource pool is an index of a search space to which the second signaling belongs.

In one embodiment, a search space to which the second signaling belongs is associated with at least one CORESET to which the second signaling belongs.

In one embodiment, a search space being used to receive the second signaling is associated with the at least one CORESET being used to receive the second signaling.

In one embodiment, an index of the first resource pool is an index of at least one CORESET to which the second signaling belongs, the second signaling explicitly indicating an index of the first resource set in the first resource pool.

In one embodiment, an index of the first resource pool is an index of at least one CORESET to which the second signaling belongs, the second signaling implicitly indicating an index of the first resource set in the first resource pool.

In one embodiment, if the second signaling explicitly indicates an index of the first resource set in the first resource pool, at least one spatial parameter of the first signaling is related to at least one of an index of the first resource set in the first resource pool or an index of the first resource pool; the index of the first resource pool is an index of at least one CORESET to which the second signaling belongs.

In one embodiment, if the second signaling implicitly indicates an index of the first resource set in the first resource pool, at least one spatial parameter of the first signaling is related to at least one of an index of the first resource set in the first resource pool or an index of the first resource pool; the index of the first resource pool is an index of at least one CORESET to which the second signaling belongs.

### Embodiment 9

Embodiment 9 illustrates a schematic diagram of at least one spatial parameter of a third signaling relating to at least one spatial parameter of a first signal according to one embodiment of the present application.

In Embodiment 9, at least one spatial parameter of the third signaling is related to at least one spatial parameter of the first signal.

In one embodiment, the first node assumes that at least one spatial parameter of the third signaling is related to at least one spatial parameter of the first signal.

In one embodiment, the antenna port quasi co-location properties of the third signaling and the antenna port quasi co-location properties of the first signaling are unrelated.

In one embodiment, the antenna port quasi co-location properties of the third signaling and the antenna port quasi co-location properties of the second signaling are unrelated.

In one embodiment, the phrase that at least one spatial parameter of the third signaling is related to at least one spatial parameter of the first signal includes: determining at least one spatial parameter of the third signaling based on at least one spatial parameter of the first signal.

In one embodiment, the phrase that at least one spatial parameter of the third signaling is related to at least one spatial parameter of the first signal includes: a spatial parameter of the third signaling being related to a spatial parameter of the first signal; the spatial parameter being antenna port quasi co-location properties.

In one embodiment, the phrase that at least one spatial parameter of the third signaling is related to at least one spatial parameter of the first signal includes: at least one of an index of the first resource set in the first resource pool or an index of the first resource pool being used to determine at least one spatial parameter of the third signaling.

In one embodiment, the phrase that at least one spatial parameter of the third signaling is related to at least one spatial parameter of the first signal includes: at least one spatial parameter of the third signaling being associated with the first SSB.

In one subembodiment, the antenna port quasi co-location properties of the third signaling and the antenna port quasi co-location properties of the first SSB are identical.

In one subembodiment, the antenna port quasi co-location properties of the third signaling and the antenna port quasi co-location properties of the first SSB are related.

In one subembodiment, the antenna port quasi co-location properties of the third signaling and the spatial parameter of the first SSB are related.

In one subembodiment, the first SSB is used for receiving the third signaling.

In one subembodiment, the third signaling is received based on the spatial parameter of the first SSB.

### Embodiment 10

Embodiment 10 illustrates a schematic diagram of at least one spatial parameter of a third signaling relating to at least one of an index of a first resource set in a first resource pool or an index of a first resource pool according to one embodiment of the present application.

In Embodiment 10, at least one spatial parameter of the third signaling is related to at least one of an index of the first resource set in the first resource pool or an index of the first resource pool.

In one embodiment, at least one spatial parameter of the third signaling means: antenna port quasi co-location properties of the third signaling.

In one embodiment, the antenna port quasi co-location properties of the third signaling and the antenna

port quasi co-location properties of the first signaling are both related to at least one of an index of the first resource set in the first resource pool or an index of the first resource pool.

In one embodiment, at least one spatial parameter of the third signaling is the same as the at least one spatial parameter of the first signaling.

In one embodiment, the antenna port quasi co-location properties of the third signaling and the antenna port quasi co-location properties of the first signaling are related

In one embodiment, the antenna port quasi co-location properties of the third signaling and the antenna port quasi co-location properties of the first signaling are identical.

In one embodiment, the antenna port quasi co-location properties of the third signaling and the antenna port quasi co-location properties of the first signaling are different.

In one embodiment, the first node assumes that at least one spatial parameter of the third signaling is related to at least one of an index of the first resource set in the first resource pool or an index of the first resource pool.

In one embodiment, the sentence “at least one spatial parameter of the third signaling is related to at least one of an index of the first resource set in the first resource pool or an index of the first resource pool” includes: determining at least one spatial parameter of the third signaling according to at least one of an index of the first resource set in the first resource pool or an index of the first resource pool.

In one embodiment, the sentence “at least one spatial parameter of the third signaling is related to at least one of an index of the first resource set in the first resource pool or an index of the first resource pool” includes: at least one spatial parameter of the third signaling being related to an index of the first resource set in the first resource pool.

In one embodiment, the sentence “at least one spatial parameter of the third signaling is related to at least one of an index of the first resource set in the first resource pool or an index of the first resource pool” includes: at least one spatial parameter of the third signaling being related to an index of the first resource pool.

In one embodiment, the sentence “at least one spatial parameter of the third signaling is related to at least one of an index of the first resource set in the first resource pool or an index of the first resource pool” includes: at least one spatial parameter of the third signaling being related to both an index of the first resource set in the first resource pool and an index of the first resource pool.

### Embodiment 11

Embodiment 11 illustrates a flowchart of radio signal transmission according to a fourth embodiment

of the present application, as shown in FIG. 11. It should be particularly noted that the sequence illustrated herein does not set any limit to the signal transmission order or implementation order in the present application.

The first node U01 transmits a first signal in step S11101, the first signal including at least a random access preamble; and monitors a first signaling in a first time window in step S11102, the first signaling being used to schedule a random access response for the first signal, an end time in time domain of the first signal being used to determine a start of the first time window; and monitors a fourth signaling in a second time window in step S11103, the fourth signaling being used to schedule a random access response for the first signal, an end time in time domain of the first signal being used to determine a start of the first time window.

The second node N02 receives the first signal in step S11201.

In Embodiment 11, the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool; at least one spatial parameter of the fourth signaling is related to at least one spatial parameter of the second signaling.

In one embodiment, the first node assumes that at least one spatial parameter of the fourth signaling is related to at least one spatial parameter of the second signaling.

In one embodiment, the second time window is the first time window.

In one embodiment, the second time window and the first time window are the same time window.

In one embodiment, the second time window and the first time window are two different time windows.

In one embodiment, a start of the second time window is the same as a start of the first time window.

In one embodiment, a start of the second time window is different from a start of the first time window.

In one embodiment, a length of the second time window is the same as a length of the first time window.

In one embodiment, a length of the second time window is different from a length of the first time window.

In one embodiment, the CRC of the first signaling is scrambled by a first RNTI, while the CRC of the fourth signaling is scrambled by a second RNTI, the first RNTI being different from the second RNTI.

In one embodiment, the first RNTI is RA-RNTI; the second RNTI is C-RNTI, or CS-RNTI, or MCS-RNTI.

In one embodiment, the first RNTI is C-RNTI, or CS-RNTI, or MCS-RNTI; the second RNTI is RA-RNTI.

In one embodiment, the first RNTI is MSGB-RNTI; the second RNTI is C-RNTI, or CS-RNTI, or MCS-RNTI.

In one embodiment, the first RNTI is C-RNTI, or CS-RNTI, or MCS-RNTI; the second RNTI is MSGB-RNTI.

In one embodiment, the fourth signaling is in a format of DCI format 1_0.

In one embodiment, the phrase that at least one spatial parameter of the fourth signaling is related to at least one spatial parameter of the second signaling comprises: the antenna port quasi co-location properties of the fourth signaling and the antenna port quasi co-location properties of the second signaling being identical.

In one embodiment, the phrase that at least one spatial parameter of the fourth signaling is related to at least one spatial parameter of the second signaling comprises: the antenna port quasi co-location properties of a PDCCH used to receive the fourth signaling and the antenna port quasi co-location properties of a PDCCH used to receive the second signaling being identical.

In one embodiment, the antenna port quasi co-location properties of the fourth signaling and the antenna port quasi co-location properties of the first signaling are different.

In one embodiment, the antenna port quasi co-location properties of the fourth signaling and the antenna port quasi co-location properties of the first signaling are identical.

In one embodiment, the antenna port quasi co-location properties of the fourth signaling and the antenna port quasi co-location properties of the second signaling are identical; the antenna port quasi co-location properties of the first signaling are associated with a Type1-PDCCH CSS set.

In one embodiment, the antenna port quasi co-location properties of the fourth signaling and the antenna port quasi co-location properties of the second signaling are identical; the antenna port quasi co-location properties of the first signaling are associated with the first SSB.

### Embodiment 12

Embodiment 12 illustrates a structure block diagram of a processing device used in a first node according to one embodiment of the present application, as shown in FIG. 12. In FIG. 12, a processing device 1200 in a first node is comprised of a first receiver 1201 and a first transmitter 1202.

The first transmitter 1202 transmits a first signal, the first signal including at least a random access preamble;

the first receiver 1201 monitors a first signaling in a first time window, the first signaling being used

to schedule a random access response for the first signal, an end time in time domain of the first signal being used to determine a start of the first time window.

In Embodiment 12, the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.

The first receiver 1201 receives a second signaling, the second signaling being used to trigger the first signal; the second signaling is used to determine that the first signal is associated with the first resource set.

In one embodiment, the index of the first resource pool is an index of at least one CORESET to which the second signaling belongs.

In one embodiment, the first receiver 1201 receives a third signaling, the third signaling indicating a first amount of timing advance; herein, the third signaling includes the random access response for the first signal.

In one embodiment, at least one spatial parameter of the third signaling is related to at least one spatial parameter of the first signal.

In one embodiment, at least one spatial parameter of the third signaling is related to at least one of an index of the first resource set in the first resource pool or an index of the first resource pool.

In one embodiment, the first transmitter 1202 transmits a second signal; herein, the first amount of timing advance is used to determine a transmission time for the second signal; the second signal being associated with the first resource set.

In one embodiment, the first receiver 1201 starts or restarts the first timer as a response to the first amount of timing advance being received; herein, the first resource set is associated with the first timer.

In one embodiment, the first receiver 1201 monitors a fourth signaling in a second time window, the fourth signaling being used to schedule a random access response for the first signal, an end time in time domain of the first signal being used to determine a start of the first time window; herein, at least one spatial parameter of the fourth signaling is related to at least one spatial parameter of the second signaling.

In one embodiment, the first receiver 1201 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises the antenna 452, the receiver 454, the multi-antenna receiving processor 458 and the receiving processor 456 in FIG. 4 of the present application.

In one embodiment, the first receiver 1201 comprises the antenna 452, the receiver 454 and the receiving processor 456 in FIG. 4 of the present application.

In one embodiment, the first transmitter 1202 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1202 comprises the antenna 452, the transmitter 454, the multi-antenna transmitting processor 457 and the transmitting processor 468 in FIG. 4 of the present application.

In one embodiment, the first transmitter 1202 comprises the antenna 452, the transmitter 454 and the transmitting processor 468 in FIG. 4 of the present application.

In one embodiment, the first transmitter 1202 comprises a first sub-transmitter and a second sub-transmitter.

In one embodiment, the first receiver 1201 comprises a first sub-receiver and a second sub-receiver.

### Embodiment 13

Embodiment 13 illustrates a structure block diagram of a processing device used in a second node according to one embodiment of the present application, as shown in FIG. 13. In FIG. 13, a processing device 1300 in a second node is comprised of a second transmitter 1301 and a second receiver 1302.

The second receiver 1302 receives a first signal, the first signal including at least a random access preamble;

the second transmitter 1301 transmits a first signaling, the first signaling being used to schedule a random access response for the first signal.

In Embodiment 13, the first signaling is monitored in a first time window, and an end time in time domain of the first signal is used to determine a start of the first time window; the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.

In one embodiment, the second transmitter 1301 transmits a second signaling, the second signaling being used to trigger the first signal; the second signaling is used to determine that the first signal is associated with the first resource set.

In one embodiment, the index of the first resource pool is an index of at least one CORESET to which the second signaling belongs.

In one embodiment, the second transmitter 1301 transmits a third signaling, the third signaling indicating a first amount of timing advance; herein, the third signaling includes the random access response for the first signal.

In one embodiment, at least one spatial parameter of the third signaling is related to at least one spatial parameter of the first signal.

In one embodiment, at least one spatial parameter of the third signaling is related to at least one of an index of the first resource set in the first resource pool or an index of the first resource pool.

In one embodiment, the second receiver 1302 receives a second signal; herein, the first amount of timing advance is used to determine a transmission time for the second signal; the second signal being associated with the first resource set.

In one embodiment, as a response to the first amount of timing advance being received, the first timer is started or restarted; herein, the first resource set is associated with the first timer.

In one embodiment, the second transmitter 1301 transmits a fourth signaling, the fourth signaling being used to schedule a random access response for the first signal; herein, the fourth signaling is monitored in a second time window, and an end time in time domain of the first signal is used to determine a start of the first time window; at least one spatial parameter of the fourth signaling is related to at least one spatial parameter of the second signaling.

In one embodiment, the second transmitter 1301 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises the antenna 420, the transmitter 418, the multi-antenna transmitting processor 471 and the transmitting processor 416 in FIG. 4 of the present application.

In one embodiment, the second transmitter 1301 comprises the antenna 420, the transmitter 418 and the transmitting processor 416 in FIG. 4 of the present application.

In one embodiment, the second receiver 1302 comprises the antenna 420, the receiver 418, the multi-antenna receiving processor 472, the receiving processor 470, the controller/processor 475 and the memory 476 in FIG. 4 of the present application.

In one embodiment, the second receiver 1302 comprises the antenna 420, the receiver 418, the multi-antenna receiving processor 472 and the receiving processor 470 in FIG. 4 of the present application.

In one embodiment, the second receiver 1302 comprises the antenna 420, the receiver 418 and the receiving processor 470 in FIG. 4 of the present application.

In one embodiment, the second transmitter 1301 comprises a third sub-transmitter and a fourth sub-transmitter.

In one embodiment, the second receiver 1302 comprises a third sub-receiver and a fourth sub-receiver.

In one embodiment, the first sub-node in the present application comprises the third sub-transmitter and the third sub-receiver.

In one embodiment, the second sub-node in the present application comprises the fourth sub-transmitter and the fourth sub-receiver.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first transmitter, transmitting a first signal, the first signal including at least a random access preamble; and
a first receiver, monitoring a first signaling in a first time window, the first signaling being used to schedule a random access response for the first signal, an end time in time domain of the first signal being used to determine a start of the first time window;
wherein the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool; the first signal is a Message1 (Msg1) in a first random access procedure; the random access preamble in the first signal is explicitly indicated by a PDCCH order; and the first random access procedure is a Contention-Free Random Access (CFRA).

2. The first node according to claim 1, characterized in that the spatial parameter includes: antenna port quasi co-location properties, the antenna port quasi co-location properties being DM-RS antenna port quasi co-location properties;
or,
the spatial parameter includes: at least one of a large-scale parameter channel, or a correlation matrix, or a transmitting beam, or a receiving beam or a transmitting/receiving beam pair.

3. The first node according to claim 1, characterized in that the first signaling is in a format of DCI format 1_0, and a Cyclic Redundancy Check (CRC) of the first signaling is scrambled by a RA-RNTI (i.e., Random Access Radio Network Temporary Identifier).

4. The first node according to claim 1, characterized in that at least one spatial parameter of the first signaling is associated with a Type1-PDCCH CSS set; the sentence “at least one spatial parameter of the first signaling is related to at least one of an index of the first resource set in the first resource pool or an index of the first resource pool” includes: at least one of the index of the first resource set in the first resource pool or the index of the first resource pool being used, as configured or as indicated, to determine that at least one spatial parameter of the first signaling is associated with the Type1-PDCCH CSS set.

5. The first node according to claim 1, characterized in that the first resource pool includes the first resource set and a second resource set, the first resource set being associated with a first cell, and the second resource set being associated with a second cell, the second cell being associated with the first cell; the first cell is configured with a ServCellIndex, and the second cell is associated with the ServCellIndex of the first cell; a Physical Cell Identity (PCI) of the first cell is different from a PCI of the second cell.

6. The first node according to claim 1, characterized in that the index of the first resource pool is used to indicate a PCell, or, the index of the first resource pool is used to indicate a PSCell.

7. The first node according to claim 1, characterized in comprising:
the first receiver, receiving a second signaling, the second signaling being used to trigger the first signal;
wherein the second signaling is used to determine that the first signal is associated with the first resource set.

8. The first node according to claim 7, characterized in that the first signal is transmitted by a first sub-node; the first signaling is received by the first sub-node; and the second signaling is transmitted by a second sub-node; the first sub-node belongs to a first cell while the second sub-node belongs to a second cell; the first resource pool includes the first resource set and the second resource set, the first resource set being associated with the first cell, the second resource set being associated with the second cell, the second cell being associated with the first cell; the first cell is configured with a ServCellIndex, and the second cell is associated with the ServCellIndex of the first cell; a PCI of the first cell is different from a PCI of the second cell.

9. The first node according to claim 8, characterized in that the first sub-node is a TRP, and the second sub-node is a TRP; the first sub-node and the second sub-node belong to a same DU, or, the first sub-node and the second sub-node belong to two different DUs and the DU to which the first sub-node belongs and the DU to which the second sub-node belongs belong to a same CU, or, the first sub-node and the second sub-node belong to two different DUs and the DU to which the first sub-node belongs and the DU to which the second sub-node belongs belong to two different CUs.

10. The first node according to claim 7, characterized in that the second signaling indicates at least one of the index of the first resource set in the first resource pool or the index of the first resource pool.

11. The first node according to claim 7, characterized in that the index of the first resource pool is an index of a cell used for receiving the second signaling.

12. The first node according to claim 7, characterized in that the second signaling includes a DCI format 1_0; the second signaling includes a Identifier for DCI formats field, the Identifier for DCI formats field being set to 1; the second signaling includes a Frequency domain resource assignment field, the Frequency domain resource assignment field being set to all ones; and the second signaling includes a Random Access Preamble index field, the Random Access Preamble index field not being set to all zeros.

13. The first node according to claim 1, characterized in that the index of the first resource pool is an index of at least one CORESET to which the second signaling belongs.

14. The first node according to claim 13, characterized in that the at least one CORESET includes: one CORESET pool.

15. The first node according to claim 13, characterized in that the second signaling implicitly indicates the index of the first resource set in the first resource pool; the at least one CORESET to which the second signaling belongs is indexed by a coresetPoolIndex; and the at least one CORESET to which the second signaling belongs is associated with the second cell.

16. The first node according to claim 1, characterized in comprising:
the first receiver, receiving a third signaling, the third signaling indicating a first amount of timing advance:
wherein the third signaling includes the random access response for the first signal; the first signaling is used to schedule the third signaling; the third signaling includes a Timing Advance Command field, the Timing Advance Command field indicating the first amount of timing advance.

17. The first node according to claim 16, characterized in that at least one spatial parameter of the third signaling is related to at least one of an index of the first resource set in the first resource pool or an index of the first resource pool; the spatial parameter includes: antenna port quasi co-location properties, the antenna port quasi co-location properties being DM-RS antenna port quasi co-location properties; the antenna port quasi co-location properties of the third signaling and the antenna port quasi co-location properties of the first signaling are identical.

18. The first node according to claim 16, characterized in comprising:
the first receiver, starting or restarting a first timer as a response to the first amount of timing advance being receive;
wherein the first resource set is associated with the first timer; only the first resource set in the first resource pool is associated with the first timer; if the first timer is running, the first node considers that an uplink transmission associated with the first resource set is synchronized; if the first timer is not running, the first node considers that an uplink transmission associated with the first resource set is non-synchronized.

19. A second node for wireless communications, comprising:
a second receiver, receiving a first signal, the first signal including at least a random access preamble; and
a second transmitter, transmitting a first signaling, the first signaling being used to schedule a random access response for the first signal;
wherein the first signaling is monitored in a first time window, and an end time in time domain of the first signal is used to determine a start of the first time window; the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.

20. A method in a first node for wireless communications, comprising:
transmitting a first signal, the first signal including at least a random access preamble; and
monitoring a first signaling in a first time window, the first signaling being used to schedule a random access response for the first signal, an end time in time domain of the first signal being used to determine a start of the first time window;
wherein the first signal is associated with a first resource set, the first resource set belonging to a first resource pool, the first resource pool including multiple resource sets, any two resource sets included in the first resource pool being associated with a same serving cell; at least one spatial parameter of the first signaling is related to at least one of an index of the first resource set in the first resource pool or an index of the first resource pool.
